(19) United States
(12) Patent Application Publication
(10) Pub. No.: US 2024/0031780 A1
(43) Pub. Date: Jan. 25, 2024

(54) TECHNIQUES FOR APPLICATION AND ACCELERATOR COMMUNICATIONS OF A DISTRIBUTED UNIT

(71) Applicant: QUALCOMM Incorporated, San Diego, CA (US)

(72) Inventors: Andrei Dragos RADULESCU, La Jolla, CA (US); Timothy CAREY, Aledo, TX (US); Faiyaz BAXAMUSA, San Diego, CA (US); Kalyan KUPPUSWAMY, San Diego, CA (US); Douglas KNISELY, Redmond, WA (US); Rajat PRAKASH, San Diego, CA (US)

(21) Appl. No.: 18/349,108

(22) Filed: Jul. 7, 2023

Related U.S. Application Data
(60) Provisional application No. 63/388,546, filed on Jul. 12, 2022.

(51) Int. Cl. H04W 4/20; H04W 4/12; H04W 8/30

(52) U.S. Cl. CPC H04W 4/20; H04W 4/12; H04W 8/30

(57) ABSTRACT

Methods, systems, and devices for wireless communications are described. An application and an accelerator associated with a distributed unit (DU) may be configured to identify context information comprising a first identifier associated with the accelerator of the DU, a second identifier associated with the application, a third identifier associated with a profile instance associated with the accelerator, a fourth identifier associated with a radio unit associated with the DU, or any combination thereof, and exchange messages with the one another based on the identified context information.

### CROSS REFERENCE

The present application for patent claims the benefit of U.S. Provisional Patent Application No. 63/388,546 by RADULESCU et al., entitled “TECHNIQUES FOR APPLICATION AND ACCELERATOR COMMUNICATIONS OF A DISTRIBUTED UNIT,” filed Jul. 12, 2022, assigned to the assignee hereof, and expressly incorporated by reference herein.

### FIELD OF TECHNOLOGY

The following relates to wireless communications, including techniques for application and accelerator communications of a distributed unit (DU).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In the context of an open radio access network (O-RAN) architecture, different functions of a base station or network entity may be physically and/or logically divided up across multiple devices or components. For example, an O-RAN network entity may include a radio unit (RU) and a distributed unit (DU), where the RU performs wireless communications with other devices (e.g., UEs) via a physical layer, and where components of the DU perform higher-layer functions to support communications performed by the RU. The physical and logical division of O-RAN network entities may result in some with exchanging information between the components of the O-RAN network entities, as well as between the O-RAN network entities and other wireless devices such as UEs.

### SUMMARY

The described techniques relate to improved methods, systems, devices, and apparatuses that support techniques for application and accelerator communications of a distributed unit (DU). Generally, aspects of the present disclosure are directed to signaling that supports the exchange of context information between an application and an accelerator of a DU to enable efficient communication of data models (DMs) between the respective devices, where the DMs support communications between the accelerator and a radio unit (RU) associated with the DU. For example, an accelerator may provide context information to the application, which may enable the application to retrieve configuration information associated with a DM hosted at the application, the RU, or both, and provide the configuration information to the accelerator. Conversely, the application may provide context information to the accelerator, which may enable the accelerator to retrieve configuration information associated with a DM hosted at the accelerator and provide the configuration information to the application. In some examples, aspects of the present disclosure may enable a management plane (M-plane) interface between an RU and an DU of an open radio access network (O-RAN) entity to be terminated at the application of the DU, as opposed to the accelerator of the DU.

A method for wireless communication at an application executable by a DU of a radio access network (RAN) is described. The method may include identifying context information including a first identifier associated with an accelerator of the DU, a second identifier associated with the application, a third identifier associated with a profile instance associated with the accelerator, a fourth identifier associated with an RU associated with the DU, or any combination thereof and exchanging messages with the accelerator based on the identified context information.

An apparatus for wireless communication at an application executable by a DU of a RAN is described. The apparatus may include at least one processor, at least one memory coupled with the at least one processor, and instructions stored in the at least one memory. The instructions may be executable by the at least one processor to cause the apparatus to identify context information including a first identifier associated with an accelerator of the DU, a second identifier associated with the application, a third identifier associated with a profile instance associated with the accelerator, a fourth identifier associated with an RU associated with the DU, or any combination thereof and exchange messages with the accelerator based on the identified context information.

Another apparatus for wireless communication at an application executable by a DU of a RAN is described. The apparatus may include means for identifying context information including a first identifier associated with an accelerator of the DU, a second identifier associated with the application, a third identifier associated with a profile instance associated with the accelerator, a fourth identifier associated with an RU associated with the DU, or any combination thereof and means for exchanging messages with the accelerator based on the identified context information.

A non-transitory computer-readable medium storing code for wireless communication at an application executable by a DU of a RAN is described. The code may include instructions executable by a processor to identify context information including a first identifier associated with an accelerator of the DU, a second identifier associated with the application, a third identifier associated with a profile instance associated with the accelerator, a fourth identifier associated with an RU associated with the DU, or any combination thereof and exchange messages with the accelerator based on the identified context information.

In some examples of the method, apparatuses, and non-transitory computer-readable medium described herein, exchanging the messages may include operations, features, means, or instructions for providing the context information to the accelerator and obtaining, from the accelerator based on providing the context information, information associated with a DM hosted at the accelerator.

In some examples of the method, apparatuses, and non-transitory computer-readable medium described herein, exchanging the messages may include operations, features, means, or instructions for obtaining the context information from the accelerator and providing, to the accelerator based on obtaining the context information, information associated with a DM for communications between the accelerator and the RU associated with the DU.

Some examples of the method, apparatuses, and non-transitory computer-readable medium described herein may further include operations, features, means, or instructions for providing, to the RU via an interface between the application and the RU, a request for the information and obtaining the information from the RU via the interface and in response to the request. In some examples, the information obtained from the RU is further conveyed to the accelerator via a second interface between the application and the accelerator. In some of these examples, the accelerator uses the information to provision a DM that the accelerator hosts.

Some examples of the method, apparatuses, and non-transitory computer-readable medium described herein may further include operations, features, means, or instructions for obtaining, from the accelerator based on providing the information, a first message indicating a result of a validation procedure associated with the information.

In some examples of the method, apparatuses, and non-transitory computer-readable medium described herein, the first message indicates a failure of the validation procedure and the method, apparatuses, and non-transitory computer-readable medium may include further operations, features, means, or instructions for providing, to the accelerator in response to the failure, a second message instructing the accelerator to convey additional information regarding the failure associated with the context information and obtaining, from the accelerator in response to the second message, a third message including the additional information associated with the context information, for the communications between the accelerator and the RU.

In some examples of the method, apparatuses, and non-transitory computer-readable medium described herein, obtaining, based on the additional information, second additional information for a second DM and providing, to the accelerator, a fourth message conveying the second additional information.

In some examples of the method, apparatuses, and non-transitory computer-readable medium described herein, the first message indicates a failure of the validation procedure and the method, apparatuses, and non-transitory computer-readable medium may include further operations, features, means, or instructions for providing, to the accelerator based on the failure, a second message identifying additional information for a second DM, where the additional information includes a modified version of the information.

In some examples of the method, apparatuses, and non-transitory computer-readable medium described herein, the first message indicates a failure of the validation procedure and the method, apparatuses, and non-transitory computer-readable medium may include further operations, features, means, or instructions for obtaining, from the accelerator based on the failure, an indication of additional information for a second DM, the additional information for producing a modified version of the information.

In some examples of the method, apparatuses, and non-transitory computer-readable medium described herein, the profile instance associated with the accelerator may be associated with a carrier, a physical context, a baseband context associated with the accelerator, or any combination thereof.

In some examples of the method, apparatuses, and non-transitory computer-readable medium described herein, the context information further includes an indication of applicable antenna panels associated with one or more transmission reception points.

In some examples of the method, apparatuses, and non-transitory computer-readable medium described herein, the first identifier corresponds to at least two profile instances of a set of multiple profiles instances.

In some examples of the method, apparatuses, and non-transitory computer-readable medium described herein, the context information includes a first set of multiple identifiers associated with a set of multiple profile instances associated with the accelerator, a second set of multiple identifiers associated with a set of multiple RUs including the RU, a third set of multiple identifiers associated with a set of multiple applications including the application, or any combination thereof.

A method for wireless communication at an accelerator associated with a DU of a RAN is described. The method may include identifying context information including a first identifier associated with the accelerator, a second identifier associated with an application of the DU, a third identifier associated with a profile instance associated with the accelerator, a fourth identifier associated with an RU associated with the DU, or any combination thereof and exchanging messages with the application based on the identified context information.

An apparatus for wireless communication at an accelerator associated with a DU of a RAN is described. The apparatus may include at least one processor, at least one memory coupled with the at least one processor, and instructions stored in the at least one memory. The instructions may be executable by the at least one processor to cause the apparatus to identify context information including a first identifier associated with the accelerator, a second identifier associated with an application of the DU, a third identifier associated with a profile instance associated with the accelerator, a fourth identifier associated with an RU associated with the DU, or any combination thereof and exchange messages with the application based on the identified context information.

Another apparatus for wireless communication at an accelerator associated with a DU of a RAN is described. The apparatus may include means for identifying context information including a first identifier associated with the accelerator, a second identifier associated with an application of the DU, a third identifier associated with a profile instance associated with the accelerator, a fourth identifier associated with an RU associated with the DU, or any combination thereof and means for exchanging messages with the application based on the identified context information.

A non-transitory computer-readable medium storing code for wireless communication at an accelerator associated with a DU of a RAN is described. The code may include instructions executable by a processor to identify context information including a first identifier associated with the accelerator, a second identifier associated with an application of the DU, a third identifier associated with a profile instance associated with the accelerator, a fourth identifier associated with an RU associated with the DU, or any combination thereof and exchange messages with the application based on the identified context information.

In some examples of the method, apparatuses, and non-transitory computer-readable medium described herein, exchanging the messages may include operations, features, means, or instructions for obtaining the context information from the application and providing, to the application based on obtaining the context information, information associated with a DM hosted at the accelerator.

In some examples of the method, apparatuses, and non-transitory computer-readable medium described herein, exchanging the messages may include operations, features, means, or instructions for providing the context information to the application and obtaining, from the application based on providing the context information, information associated with a DM for communications between the accelerator and the RU associated with the DU.

Some examples of the method, apparatuses, and non-transitory computer-readable medium described herein may further include operations, features, means, or instructions for providing, to the application based on obtaining the information, a first message indicating a result of a validation procedure associated with the information.

In some examples of the method, apparatuses, and non-transitory computer-readable medium described herein, the first message indicates a failure of the validation procedure and the method, apparatuses, and non-transitory computer-readable medium may include further operations, features, means, or instructions for obtaining, from the application in response to the failure, a second message instructing the accelerator to convey additional information regarding the failure associated with the context information and providing, to the application in response to the second message, a third message including the additional information associated with the context information, for communications between the accelerator and the RU.

Some examples of the method, apparatuses, and non-transitory computer-readable medium described herein may further include operations, features, means, or instructions for obtaining, from the application in response to the failure, a fourth message including second additional information for a second DM.

Some examples of the method, apparatuses, and non-transitory computer-readable medium described herein may further include operations, features, means, or instructions for obtaining, from the application, a first message including information relevant to a second DM, determining a failure of a validation procedure associated with the information, and providing, to the application based on the failure, a second message indicating a third information, where the third information may be associated with a modified version of the information.

In some examples of the method, apparatuses, and non-transitory computer-readable medium described herein, the profile instance associated with the accelerator may be associated with a carrier, a physical context, a baseband context associated with the accelerator, or any combination thereof.

In some examples of the method, apparatuses, and non-transitory computer-readable medium described herein, the context information further includes an indication of applicable antenna panels associated with one or more transmission reception points associated with the DU.

In some examples of the method, apparatuses, and non-transitory computer-readable medium described herein, the first identifier corresponds to at least two profile instances of a set of multiple profiles instances.

In some examples of the method, apparatuses, and non-transitory computer-readable medium described herein, the context information includes a first set of multiple identifiers associated with a set of multiple profile instances associated with the accelerator, a second set of multiple identifiers associated with a set of multiple RUs including the RU, a third set of multiple identifiers associated with a set of multiple applications including the application, or any combination thereof.

A method for wireless communication at an application executable by a DU of a RAN is described. The method may include communicating a first message with an accelerator of the DU, the first message including context information associated with a DM hosted at the accelerator or the application and communicating a second message with the accelerator based on the context information, the second message including configuration information associated with the DM.

An apparatus for wireless communication at an application executable by a DU of a RAN is described. The apparatus may include a processor, memory coupled with the processor, and instructions stored in the memory. The instructions may be executable by the processor to cause the apparatus to communicate a first message with an accelerator of the DU, the first message including context information associated with a DM hosted at the accelerator or the application and communicate a second message with the accelerator based on the context information, the second message including configuration information associated with the DM.

Another apparatus for wireless communication at an application executable by a DU of a RAN is described. The apparatus may include means for communicating a first message with an accelerator of the DU, the first message including context information associated with a DM hosted at the accelerator or the application and means for communicating a second message with the accelerator based on the context information, the second message including configuration information associated with the DM.

A non-transitory computer-readable medium storing code for wireless communication at an application executable by a DU of a RAN is described. The code may include instructions executable by a processor to communicate a first message with an accelerator of the DU, the first message including context information associated with a DM hosted at the accelerator or the application and communicate a second message with the accelerator based on the context information, the second message including configuration information associated with the DM.

In some examples of the method, apparatuses, and non-transitory computer-readable medium described herein, the context information includes a first identifier associated with the accelerator, a second identifier associated with the RU, a third identifier associated with a profile instance associated with the accelerator, or a fourth identifier associated with the application.

In some examples of the method, apparatuses, and non-transitory computer-readable medium described herein, the accelerator may be associated with a set of multiple profile instances including the profile instance and first identifier corresponds to at least two profile instances of the set of multiple profiles instances.

In some examples of the method, apparatuses, and non-transitory computer-readable medium described herein, the context information includes a set of multiple identifiers associated with a set of multiple profile instances associated with the accelerators, a set of multiple identifiers associated with a set of multiple RUs including the RU, a set of multiple identifiers associated with a set of multiple applications including the application, or any combination thereof and the configuration information may be associated with the set of multiple profile instances, the set of multiple RUs, the set of multiple applications, or any combination thereof.

Some examples of the method, apparatuses, and non-transitory computer-readable medium described herein may further include operations, features, means, or instructions for obtaining, from the accelerator based on providing the second message, a third message indicating a result of a validation procedure associated with the configuration information.

In some examples of the method, apparatuses, and non-transitory computer-readable medium described herein, the third message indicates a failure of the validation procedure and the method, apparatuses, and non-transitory computer-readable medium may include further operations, features, means, or instructions for providing, to the accelerator in response to the failure, a fourth message instructing the accelerator to modify the context information, obtaining, from the accelerator in response to the fourth message, a fifth message including additional context information for the communications between the accelerator and the RU, obtaining, based on the additional context information, additional configuration information for a second DM, and providing, to the accelerator, a sixth message identifying the additional configuration information.

In some examples of the method, apparatuses, and non-transitory computer-readable medium described herein, the third message indicates a failure of the validation procedure and the method, apparatuses, and non-transitory computer-readable medium may include further operations, features, means, or instructions for providing, to the accelerator based on the failure, a fourth message identifying additional configuration information for a second DM, where the additional configuration information includes a modified version of the configuration information.

In some examples of the method, apparatuses, and non-transitory computer-readable medium described herein, the third message indicates a failure of the validation procedure and the method, apparatuses, and non-transitory computer-readable medium may include further operations, features, means, or instructions for obtaining, from the accelerator based on the failure, an indication of additional configuration information for a second DM, where the additional configuration information includes a modified version of the configuration information.

In some examples of the method, apparatuses, and non-transitory computer-readable medium described herein, the first message may be obtained from the accelerator via an interface between the application and the accelerator.

Some examples of the method, apparatuses, and non-transitory computer-readable medium described herein may further include operations, features, means, or instructions for communicating, with the accelerator, an exchange configuration for exchanging information associated with the DM between the application and the accelerator, where communicating the first message, communicating the second message, or both, may be based on the exchange configuration.

In some examples of the method, apparatuses, and non-transitory computer-readable medium described herein, the exchange configuration includes one or more rules, one or more conditions, or both, for modifying the DM.

Some examples of the method, apparatuses, and non-transitory computer-readable medium described herein may further include operations, features, means, or instructions for providing, to the RU via an interface between the application and the RU and based on the context information, a request for the configuration information and obtaining the configuration information from the RU via the interface the application and the RU and based on the request, where communicating the second message may be based on the obtaining.

Some examples of the method, apparatuses, and non-transitory computer-readable medium described herein may further include operations, features, means, or instructions for obtaining, from the RU, additional configuration information associated with the DM for communications between the accelerator and the RU and obtaining, from the accelerator, a third message indicating a failure of a validation procedure associated with the additional configuration information and performed at the accelerator, where the configuration information may be obtained from the RU based on the third message. In some examples, the configuration information from the RU may be obtained via an interface between the application and the RU, or, in some other examples, the application may retrieve the configuration information from storage. In an example that is an alternative of local caching at the application, if validation failure involves the third message, the accelerator may perform the validation procedure (e.g., a validation check may be performed at the accelerator and not at the application).

Some examples of the method, apparatuses, and non-transitory computer-readable medium described herein may further include operations, features, means, or instructions for obtaining the configuration information via a cache maintained at the application, where communicating the second message may be based on the obtaining.

In some examples of the method, apparatuses, and non-transitory computer-readable medium described herein, the configuration information includes a capability associated with the RU, a set of parameters associated with communications performed by the RU, or a status associated with processing of the first message, or any combination thereof.

Some examples of the method, apparatuses, and non-transitory computer-readable medium described herein may further include operations, features, means, or instructions for providing the first message including the context information to the accelerator and obtaining the second message from the accelerator based on providing the first message, where the DM may be hosted at the accelerator.

A method for wireless communication at an accelerator associated with a DU of a RAN is described. The method may include communicating a first message with an application executable by the DU, the first message including context information associated with a DM hosted at the accelerator or the application and communicating a second message with the application based on the context information, the second message including configuration information associated with the DM.

An apparatus for wireless communication at an accelerator associated with a DU of a RAN is described. The apparatus may include a processor, memory coupled with the processor, and instructions stored in the memory. The instructions may be executable by the processor to cause the apparatus to communicate a first message with an application executable by the DU, the first message including context information associated with a DM hosted at the accelerator or the application and communicate a second message with the application based on the context information, the second message including configuration information associated with the DM.

Another apparatus for wireless communication at an accelerator associated with a DU of a RAN is described. The apparatus may include means for communicating a first message with an application executable by the DU, the first message including context information associated with a DM hosted at the accelerator or the application and means for communicating a second message with the application based on the context information, the second message including configuration information associated with the DM.

A non-transitory computer-readable medium storing code for wireless communication at an accelerator associated with a DU of a RAN is described. The code may include instructions executable by a processor to communicate a first message with an application executable by the DU, the first message including context information associated with a DM hosted at the accelerator or the application and communicate a second message with the application based on the context information, the second message including configuration information associated with the DM.

In some examples of the method, apparatuses, and non-transitory computer-readable medium described herein, the context information includes a first identifier associated with the accelerator, a second identifier associated with the RU, a third identifier associated with a profile instance associated with the accelerator, or a fourth identifier associated with the application.

In some examples of the method, apparatuses, and non-transitory computer-readable medium described herein, the accelerator may be associated with a set of multiple profile instances including the profile instance and first identifier corresponds to at least two profile instances of the set of multiple profiles instances.

In some examples of the method, apparatuses, and non-transitory computer-readable medium described herein, the context information includes a set of multiple identifiers associated with a set of multiple profile instances associated with the accelerator, a set of multiple identifiers associated with a set of multiple RUs including the RU, a set of multiple identifiers associated with a set of multiple applications including the application, or any combination thereof and the configuration information may be associated with the set of multiple profile instances, the set of multiple RUs, the set of multiple applications, or any combination thereof.

Some examples of the method, apparatuses, and non-transitory computer-readable medium described herein may further include operations, features, means, or instructions for providing, to the application based on obtaining the second message, a third message indicating a result of a validation procedure associated with the configuration information.

Some examples of the method, apparatuses, and non-transitory computer-readable medium described herein may further include operations, features, means, or instructions for obtaining, from the application, a third message including additional configuration information for a second DM, providing, to the application based on obtaining the third message, a fourth message indicating a failure of a validation procedure associated with the additional configuration information, obtaining, from the application in response to the failure, a fifth message instructing the accelerator to modify the context information, and providing, to the application in response to the fifth message, a sixth message including additional context information for the communications between the accelerator and the RU, where obtaining the second message including the configuration information may be based on the sixth message.

Some examples of the method, apparatuses, and non-transitory computer-readable medium described herein may further include operations, features, means, or instructions for obtaining, from the application, a third message including additional configuration information for a second DM and providing, to the application based on obtaining the third message, a fourth message indicating a failure of a validation procedure associated with the additional configuration information, where the second message including the configuration information may be obtained based on the fourth message, and where the configuration information includes a modified version of the additional configuration information.

Some examples of the method, apparatuses, and non-transitory computer-readable medium described herein may further include operations, features, means, or instructions for obtaining, from the application, a third message including additional configuration information for a second DM, determining a failure of a validation procedure associated with the additional configuration information, and providing, to the application based on the failure, a fourth message indicating the configuration information, where the configuration information includes a modified version of the additional configuration information.

In some examples of the method, apparatuses, and non-transitory computer-readable medium described herein, the first message may be provided to the application via an interface between the application and the accelerator.

Some examples of the method, apparatuses, and non-transitory computer-readable medium described herein may further include operations, features, means, or instructions for communicating, with the application, an exchange configuration for exchanging information associated with the DM between the application and the accelerator, where providing the first message, obtaining the second message, or both, may be based on the exchange configuration.

In some examples of the method, apparatuses, and non-transitory computer-readable medium described herein, the exchange configuration includes one or more rules, one or more conditions, or both, for modifying the DM.

In some examples of the method, apparatuses, and non-transitory computer-readable medium described herein, the configuration information includes a capability associated with the RU, a set of parameters associated with communications performed by the RU, a status associated with processing of the first message, or any combination thereof.

Some examples of the method, apparatuses, and non-transitory computer-readable medium described herein may further include operations, features, means, or instructions for providing the first message including the context information to the application, obtaining the second message including the configuration information from the application, where the DM may be associated with communications between the accelerator and an RU coupled with the DU, and communicating with the RU in accordance with the configuration information.

Some examples of the method, apparatuses, and non-transitory computer-readable medium described herein may further include operations, features, means, or instructions for communicating with the RU may be performed via a physical layer interface between the accelerator and the RU.

Some examples of the method, apparatuses, and non-transitory computer-readable medium described herein may further include operations, features, means, or instructions for obtaining the first message including the context information from the application and providing the second message to the application based on obtaining the first message, where the DM may be hosted at the accelerator.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports techniques for application and accelerator communications of a distributed unit (DU) in accordance with one or more aspects of the present disclosure.

FIG. 2 illustrates an example of a network architecture that supports techniques for application and accelerator communications of a DU in accordance with one or more aspects of the present disclosure.

FIG. 3 illustrates an example of an open radio access network (O-RAN) architecture that supports techniques for application and accelerator communications of a DU in accordance with one or more aspects of the present disclosure.

FIG. 4 illustrates an example of an O-RAN entity that supports techniques for application and accelerator communications of a DU in accordance with one or more aspects of the present disclosure.

FIG. 5 illustrates an example of a process flow that supports techniques for application and accelerator communications of a DU in accordance with one or more aspects of the present disclosure.

FIG. 6 illustrates an example of a process flow that supports techniques for application and accelerator communications of a DU in accordance with one or more aspects of the present disclosure.

FIGS. 7 and 8 show block diagrams of devices that support techniques for application and accelerator communications of a DU in accordance with one or more aspects of the present disclosure.

FIG. 9 shows a block diagram of a communications manager that supports techniques for application and accelerator communications of a DU in accordance with one or more aspects of the present disclosure.

FIG. 10 shows a diagram of a system including a device that supports techniques for application and accelerator communications of a DU in accordance with one or more aspects of the present disclosure.

FIGS. 11 through 14 show flowcharts illustrating methods that support techniques for application and accelerator communications of a DU in accordance with one or more aspects of the present disclosure.

### DETAILED DESCRIPTION

In the context of an open radio access network (O-RAN) architecture, different functions of a base station or network entity may be physically and/or logically divided up across multiple physical devices or components. For example, an O-RAN network entity may include a radio unit (RU) and a distributed unit (DU), where the RU performs wireless communications with other devices (e.g., user equipments (UEs)) via a physical (PHY) layer, and where components of the DU perform higher-layer functions to support communications performed by the RU. A DU may include an application associated with higher layers (e.g., medium access control (MAC) layer), and an accelerator (e.g., higher-PHY (HiPHY) component) that serves as an interface between the PHY layer of the RU and the upper layer of the application.

A management plane (M-plane) interface between the DU and the RU may be used to provide configuration and capability information (e.g., data models (DMs)) of the RU to the DU. In some implementations, the M-plane interface is terminated at the accelerator (e.g., the M-plane defines an interface between the accelerator and the DU). However, terminating the M-plane at the accelerator may result in increased signaling between the accelerator and the application, as the accelerator may be required to relay DMs from the RU to the application. Further, requiring the accelerator to relay DMs to the application may result in duplicative functions and processing performed at both the application and the accelerator. Other implementations may terminate the M-plane at the application itself. However, O-RAN architecture does not provide any signaling or other mechanisms that enable information received by the application via the M-plane to be requested by and/or provided to the accelerator.

Accordingly, aspects of the present disclosure are directed to techniques and signaling that enable the M-plane interface between an RU and a DU to be terminated at the application of the DU, as opposed to the accelerator of the DU. In particular, aspects of the present disclosure are directed to signaling that supports the exchange of context information between an application and an accelerator of a DU to enable efficient communication of DMs between the application and the accelerator.

For example, an application of a DU may receive context information from an accelerator of the DU, where the context information indicates context/parameters associated with communications between the accelerator and the RU (e.g., applicable carriers, RU identifier(s), accelerator identifier(s), etc.). Based on the received context information, the application may retrieve configuration information for a DM associated with the communications between the accelerator and the RU. The application may retrieve the configuration information/DM from memory, or may transmit a request to the RU via the M-plane between the application and the RU. Subsequently, the application may provide the configuration information/DM to the accelerator so that the accelerator may use the configuration information to communicate with the RU. In some implementations, the application and/or the accelerator may perform a validation procedure on the obtained configuration information, and may be able modify the configuration and/or request new configuration information in the event the validation fails.

Conversely, the accelerator of the DU may receive context information from the application of the DU, where the context information indicates context/parameters associated with a DM hosted at the accelerator (e.g., applicable carriers, RU identifier(s), accelerator identifier(s), etc.). Based on the received context information, the accelerator may retrieve configuration information for the DM, and provide the retrieved DM to the application in response to the received context information.

Aspects of the disclosure are initially described in the context of wireless communications systems. Additional aspects of the disclosure are described in the context of an example O-RAN entity and an example process flow. Aspects of the disclosure are further illustrated by and described with reference to apparatus diagrams, system diagrams, and flowcharts that relate to techniques for application and accelerator communications of a DU.

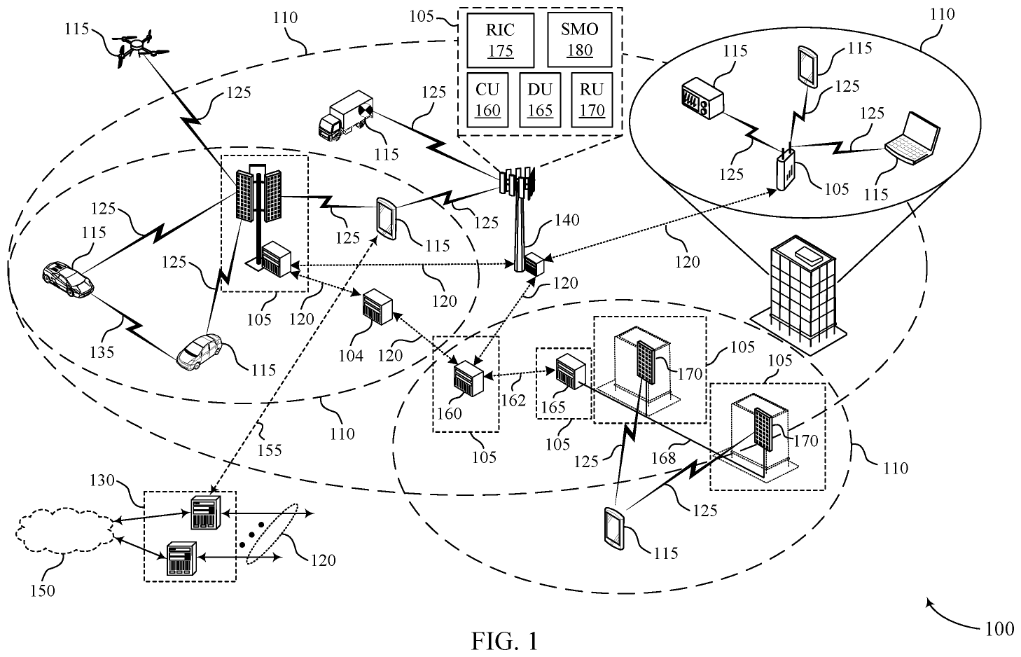

FIG. 1 illustrates an example of a wireless communications system 100 that supports techniques for application and accelerator communications of a DU in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an O-RAN (e.g., a network configuration sponsored by the O-RAN Alliance), or a virtualized RAN (vRAN) (e.g., a cloud RAN (C-RAN)). For example, a network entity 105 may include one or more of a central unit (CU) 160, a DU 165, an RU 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., PHY layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for application and accelerator communications of a DU as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, the wireless communications system 100 may support techniques and signaling that enable an M-plane interface between an RU and a DU of an O-RAN network entity 105 to be terminated at the application of the DU, as opposed to the accelerator of the DU. In particular, the wireless communications system 100 may include O-RAN network entities 105 which support signaling that enables the exchange of context information between an application and an accelerator of a DU of the O-RAN network entities 105 to enable efficient communication of DMs between the application and the accelerator.

For example, the wireless communications system 100 may include an O-RAN network entity 105 that includes a DU and an RU. In this example, an application of the DU may receive context information from an accelerator of the DU, where the context information indicates context/parameters associated with communications between the accelerator and the RU (e.g., applicable carriers, RU identifier(s), accelerator identifier(s), etc.). Based on the received context information, the application may retrieve configuration information for a DM associated with the communications between the accelerator and the RU. The application may retrieve the configuration information/DM from memory, or may transmit a request to the RU via the M-plane between the application and the RU. Subsequently, the application may provide the configuration information/DM to the accelerator so that the accelerator may use the configuration information to communicate with the RU. In some implementations, the application and/or the accelerator may perform a validation procedure on the obtained configuration information, and may be able modify the configuration and/or request new configuration information in the event the validation fails.

Techniques described herein may enable the M-plane interface between a DU and an RU of an O-RAN network entity 105 to be terminated at an application of the DU, as opposed to an accelerator of the DU. In particular, techniques of the present disclosure support signaling between the application and the accelerator of the DU which enables the M-plane interface to be terminated at the application. By enabling the M-plane interface to be terminated at the application, rather than the accelerator, techniques described herein may reduce or eliminate the need for the accelerator to relay DMs received from the RU to the application, thereby reducing signaling and processing performed at the DU. Additionally, by enabling the M-plane interface to be terminated at the application, techniques described herein may reduce the amount of processing operations that that are duplicated across both the application and the accelerator, thereby reducing power consumption and complexity of the DU and O-RAN network entity 105.

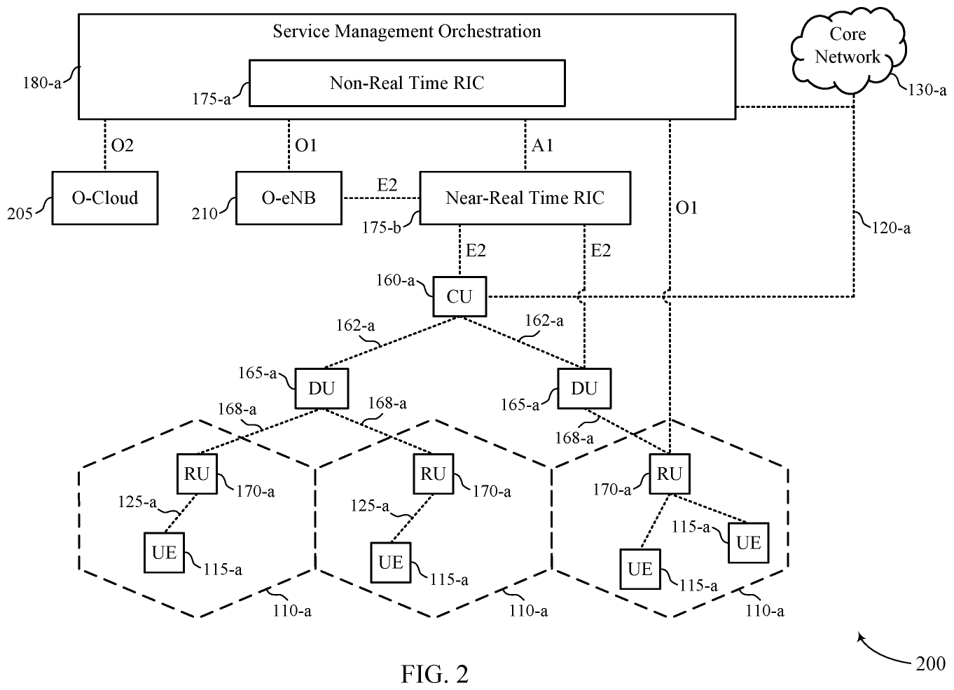

FIG. 2 illustrates an example of a network architecture 200 (e.g., a disaggregated base station architecture, a disaggregated RAN architecture) that supports techniques for application and accelerator communications of a DU in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (0-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

As will be described in further detail herein, the network architecture 200 may illustrate an example of an O-RAN network entity 105 that supports signaling which enables an M-plane interface between an RU 170 and a DU 165 of the O-RAN network entity 105 to be terminated at the application of the DU 165.

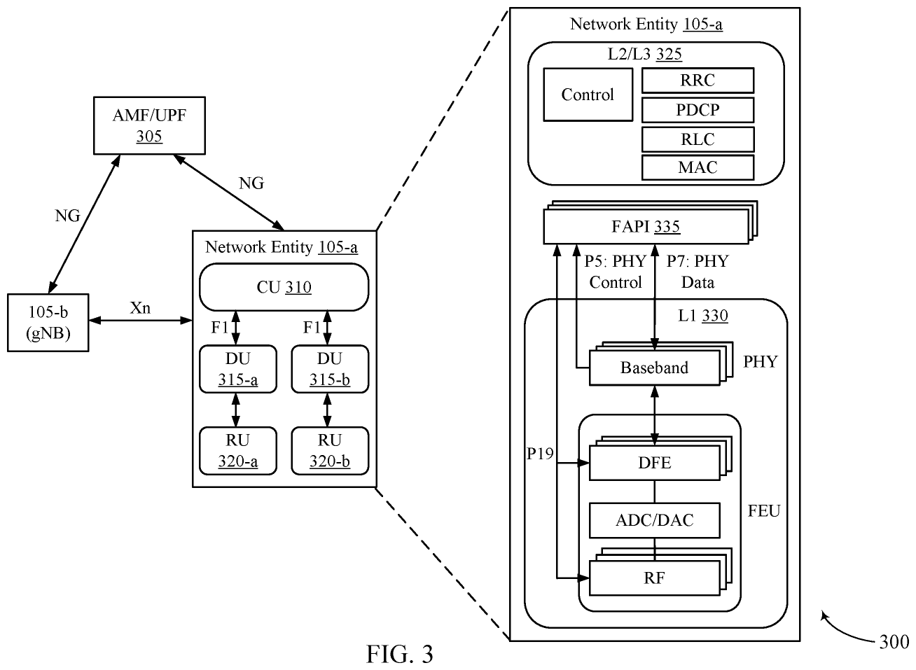

FIG. 3 illustrates an example of an O-RAN architecture 300 that supports techniques for application and accelerator communications of a DU in accordance with one or more aspects of the present disclosure. In some examples, aspects of the O-RAN architecture 300 may implement, or be implemented by, aspects of the wireless communications system 100, the network architecture 200, or both. In particular, the O-RAN architecture 300 may include an O-RAN network entity that supports signaling which enables an M-plane interface between an RU and a DU of the O-RAN network entity 105 to be terminated at the application of the DU, as described with respect to FIGS. 1 and 2.

In some implementations of the O-RAN architecture 300, an access and mobility management function (AMF 305) or a user plane function (UPF) (hereinafter referred to as AMF 305) may be connected to one or more network entities 105-a, 105-b (e.g., gNBs) via a Next Generation (NG) interface. Network entities 105 may be connected to each other via Xn interfaces. A network entity 105 may include a CU 310, which may be connected to one or more DUs 315 via F1 interfaces.

A DU 315 may include a layer 2 (L2) and a layer 3 (L3) (hereinafter L2/L3 325), which may be associated with a control layer, an RRC layer, a PDCP layer, an RLC layer, and a MAC layer. The L2/L3 325 may communicate with a layer 1 (L1 330) via a functional application platform interface (FAPI 335). The FAPI 335 may enable slot-by-slot operation. The FAPI 335 may be stateless and may enable over-the-air transmissions and receptions. The L1 330 may be associated with a PHY layer and a front-end unit (FEU). The PHY layer may be associated with a baseband, which may include digital beamforming. The baseband may communicate with the FAPI 335 via a P5 interface, which may be associated with PHY control, and via a P7 interface, which may be associated with PHY data. The FEU may be associated with a digital front-end (DFE), an analog-to-digital converter (ADC) and a digital-to-analog converter (DAC), and an RF, which may be associated with analog beamforming. The DFE and the RF may communicate with the FAPI via a P19 interface, which may be associated with FEU control.

It is noted herein that the O-RAN architecture 300 illustrated in FIG. 3 is provided solely for example and illustrative purposes. In this regard, other examples of O-RAN architectures may differ from what is described with respect to the O-RAN architecture 300.

An O-RAN front haul (FH) (OFH) may provide a stateless interface operating at a symbol resolution between a high PHY layer associated with an O-DU 315 (e.g., DU 315-a, DU 315-b) and a low PHY layer associated with an O-RU 320 (e.g., RUs 320-a, 320-b). The O-RAN FH may be associated with a control plane (C-plane). The C-plane may provide scheduling and beamforming commands, multiple numerologies, channel estimates to the O-RU 320, unlicensed access support, a section extension for updating beam weights, and/or non-contiguous resource block patterns. The O-RAN FH may be associated with a user plane (U-plane). The U-plane may provide transport of samples scheduled over the C-plane (or semi-statically configured over an M-plane), and/or a support of compression. The O-RAN FH may be associated with a synchronization plane, which may provide a profile of protocols and mechanisms for ensuring timely delivery of the C-plane and the U-plane.

A FAPI 335 may be an example of an interface between the L2/L3 325 and the L1 330 in an O-DU 315, whereas the O-RAN FH may provide connectivity between the O-DU 315 and an O-RU 320. In some implementations, the FAPI 335 may be independent of the O-RAN FH.

The O-DU 315 may employ an accelerator (e.g., a hardware accelerator and an associated library/driver) to improve a performance of the O-DU 315. The accelerator may be implemented by using the FAPI 335 to support interactions at the O-DU 315. Since the FAPI 335 has a limited awareness of the O-RAN FH (which may provide connectivity between the O-DU 315 and an O-RU 320), the accelerator may need to generate O-RAN FH messages for both the C-plane and the U-plane. However, a value of the accelerator may primarily apply for the U-plane with respect to in-phase and quadrature (I/Q) signal generation and decoding, or for C-plane generation of beamforming weights, and a specific O-DU 315 implementation may not require the assistance of the accelerator for generating other C-plane messages or fields. The accelerator may use high performance hardware that is not well suited for complex data structures, but may be well suited for processing FH U-plane messages (e.g., I/Q samples to and from the O-RU 320) or beam weights (e.g., complex-valued samples to or from the O-RU 320). As a result, generating or receiving the O-RAN FH messages for all C-plane and U-plane messages may not be as valuable as focusing the accelerator on hardware-intense message generation or reception in the O-DU 315.

In some aspects, an O-DU 315 may generate or receive, at an O-DU 315 application that executes on the O-DU 315, a C-plane message. The O-DU 315 may transit, between the O-DU 315 application and O-RU 320, the C-plane message via a passthrough of an accelerator of the O-DU 315 that is in-line with the O-DU 315 application. The C-plane message may pass through the accelerator of the O-DU 315 and may not be subjected to hardware acceleration at the accelerator, beyond possible transposition between an application message payload and a transport medium. Such transposition may involve I/Q sample or beamform weight compression or decompression or the addition or removal of transport adaptation. In other words, for passthrough, a message payload may be fully generated or interpreted at the O-DU 315 application, and the accelerator may at most be involved in the transposition of compression/decompression.

Further, the C-plane message may be a first message, and the O-DU 315 may generate or receive, at the accelerator, a second control or U-plane message (a second message) based at least in part on a FAPI 335 exchange between the accelerator and the O-DU 315 application. The second message may be subjected to hardware acceleration at the accelerator. The O-DU 315 may transit, via the accelerator with the O-RU 320, the second message. As a result, certain messages (e.g., C-plane messages) generated at the O-DU 315 may pass through the accelerator, while other messages (e.g., C-plane messages generated at the O-DU 315 and U-plane messages) may be directed to the accelerator for hardware acceleration, thereby improving a performance of the accelerator.

In some aspects, some C-plane messages may not be terminated at the accelerator in the O-DU 315, such that a C-plane transparency may be increased for the accelerator. Certain C-plane messages may be generated or received in the O-DU 315 application, and these C-plane messages may pass through the accelerator and be exchanged with the O-RU 320. The passthrough of certain C-plane messages may minimize book-keeping at the accelerator, as well as minimize a quantity of translations without any added value at the accelerator, thereby improving a performance of the accelerator. The passthrough of certain C-plane messages at the accelerator may result in additional cycles available at the accelerator for more high-value functions. Further, the management plane may primarily be terminated in the O-DU 315 application and not in the accelerator. As a result, the FAPI 335 exchanges may be used in a way to extract precisely as much value from the accelerator as needed by the O-DU 315 application.

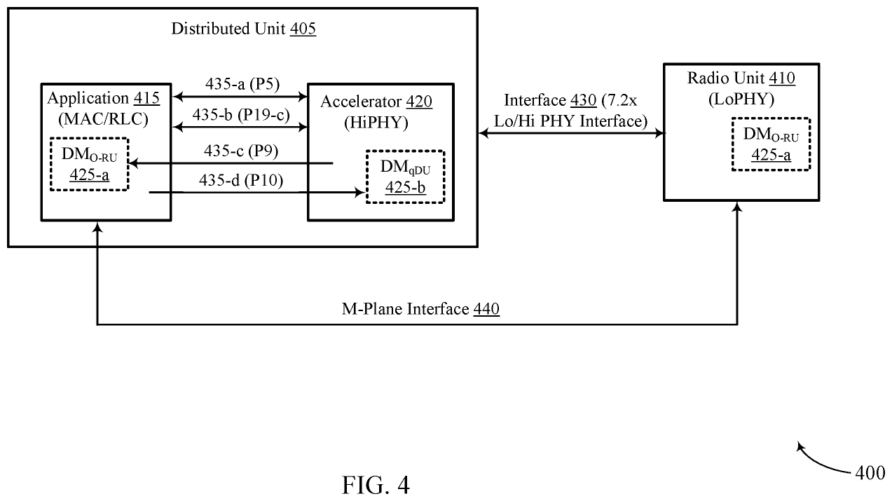

FIG. 4 illustrates an example of an O-RAN entity 400 that supports techniques for application and accelerator communications of a DU in accordance with one or more aspects of the present disclosure. In some examples, aspects of the O-RAN entity 400 may implement, or be implemented by, aspects of the wireless communications system 100, the network architecture 200, the O-RAN architecture 300, or any combination thereof. In particular, the O-RAN entity 400 may support signaling which enables an M-plane interface between an RU and a DU of the O-RAN entity 400 to be terminated at the application of the DU, as described with respect to FIGS. 1-3.

The O-RAN entity 400 may include a DU 405 and an RU 410, which may be examples of DUs 165 and RUs 170 as described with reference to FIG. 2, and/or the DUs 315 and RUs 320 as described with reference to FIG. 3. In some implementations, the O-RAN entity 400 may include multiple RUs 410 that are communicatively coupled to (e.g., controlled by) the DU 405. In some implementations, lower-layer functionality of the O-RAN entity 400 may be implemented by the RU 410 that is controlled by the DU 405. For example, the RU 410 may include or correspond to a logical node that hosts RF processing functions, low-PHY layer functions (e.g., FFT, iFFT, digital beamforming, PRACH extraction and filtering, or the like), or both. In the O-RAN entity 400 illustrated in FIG. 4, the RU 410 a may be configured to perform communications (e.g., OTA communications) with other wireless devices, such as UEs 115.

The DU 405 may include an application 415 and an accelerator 420. As noted previously herein, the DU 405 may correspond to a logical unit that includes one or more functions (e.g., base station functions, RAN functions) to control the operation of the RU 410. In some examples, the DU 405 may host, at least partially, one or more of an RLC layer, a MAC layer, and one or more aspects of a PHY layer. For example, the application 415 may include or support upper layers, such as the MAC and RLC layer, and the accelerator 420 may support a HiPHY layer, such as modules for FEC encoding and decoding, scrambling, modulation and demodulation, or the like.

In some aspects, the accelerator 420 may include one or more sets of hardware units, where each hardware unit is associated with an identifier corresponding to the accelerator 420. In some aspects, each hardware unit may include or support a carrier or profile instance (e.g., accelerator profile instance, where a single profile instance is associated with a FAPI PHY ID), which may be unique within the context of the hardware unit, or the context of the accelerator 420. In some aspects, the profile instance may refer to the accelerator 420 resources dedicated to generate and receive a baseband carrier as it applies to FAPI. where the context for the profile instance may be identified by a PHY ID, as shown in Table 1.

The different operations/functions supported by (or performed at) the DU 405 and the RU 410 may be based on a functional split between the respective components, such as a lower-layer functional split. The O-RAN entity 400 shown in FIG. 4 illustrates an example of a 7.2× split implementation of the respective components of the O-RAN entity 400, where the RU 410 supports PHY layer communications such as sampling, conversion, etc., the accelerator 420 (e.g., hi-PHY, or upper-PHY) supports some data processing operations (e.g., digital beamforming, decoding, synchronization, FEC), and the application 415 (e.g., MAC and other upper layers) support various upper-layer functions (e.g., mapping U-plane to TBs, synchronization of C-plane, etc.).

The respective components of the O-RAN entity 400 may communicate with one another via one or more interfaces. For example, the DU 405 and the RU 410 may communicate with one another via an interface 430, which may be an example, of a Lo/Hi PHY interface. Moreover, as noted previously herein, the FAPI enables communications between L1 and L2/L3, and may therefore define one or more interfaces between the application 415 and the accelerator 420 illustrated in FIG. 4. The FAPI may be illustrated by one or more interfaces 435-a, 435-b, 435-c, and 435-d between the application 415 and the accelerator 420. The FAPI may define an interface between the MAC and upper PHY, which may be associated with a physical and logical split between hardware applications/operations (supported by the accelerator 420) and software applications/operations (supported by the application 415). In addition to enabling slot-by-slot operation and OTA transmission/reception, the FAPI may be configured to support heterogeneous architectures within the O-RAN entity 400.

Further, as shown in FIG. 4, the O-RAN entity 400 may include an M-plane interface 440 that facilitates communications between the DU 405 and the RU 410. In the context of the 7.2× split implementation illustrated in FIG. 4, the M-plane interface may terminate at the HiPHY (e.g., accelerator 420) or the application 415. However, in some conventional wireless communications systems, neither HiPHY nor application 415 termination may be fully supported.

In some implementations, the M-plane interface 440 may be terminated at the HiPHY (e.g., accelerator 420) (not shown). In such cases where the M-plane interface 440 terminates at the accelerator 420 in HiPHY, the accelerator 420 may be able to discover RU 410 capabilities, and configure RU 410 parameters with minimal assistance from the application 415. In other words, terminating the M-plane interface 440 at the accelerator 420 may enable the accelerator 420 and the RU 410 to exchange DMs 425 directly between the respective components. However, terminating the M-plane interface 440 at the accelerator 420 may result in increased signaling between the accelerator 420 and the application 415, as the accelerator 420 may be required to relay DMs 425 from the RU 410 to the application 415. In other words, some O-RAN M-plane interface 440 capabilities and configurations may be expected at the MAC layer, but are unable to be directly retrieved by the application 415 (e.g., capabilities not exposed to MAC via FAPI). Further, requiring the accelerator 420 to relay information received via the M-plane interface 440 to the application 415 may result in duplicative functions and processing performed at both the application 415 and the accelerator 420.

Comparatively, some other implementations may terminate the M-plane interface 440 at the application 415 itself. Terminating the M-plane interface 440 at the application 415 may enable the application 415 to discover RU 410 capabilities and configure RU 410 parameters. However, some conventional O-RAN architectures do not provide any signaling or other mechanisms that enable information received by the application 415 via the M-plane interface 440 to be requested by and/or provided to the accelerator 420. In other words, in cases where the M-plane interface 440 terminates at the application 415, there is no current open support for HiPHY (e.g., accelerator 420) to discover RU 410 capabilities and, where necessary, to enable the HiPHY to configure parameters at the RU 410. As such, conventional O-RAN architectures do not support any signaling or mechanisms that may be used to convey O-RU 410 capabilities to HiPHY and to extract O-RU 410 configuration information from HiPHY.

Additionally, in the context of the O-RAN entity 400 architecture, the DU 405 may require fault, configuration, accounting, performance, and security (FCAPS) for DU 405 specific capabilities. In the O-RAN entity 400, DU 405-specific capability and configuration parameters may be expected to be represented via a YANG model, a modeling language that is used in the O-RAN architecture to model the configuration and operational state of the RU 410. Some of these parameters may map to existing capabilities and parameters (e.g., cell configuration, channel configuration, etc.) exposed via FAPI parameters and configuration APIs (e.g., via P9 interface 435-a). However, other parameters are not subject to FAPI P5 (e.g., interface 435-a), and may not be communicated via the interface 435-a, such as DU 405 S-plane parameters, and DU 405-side control user synchronization (CUS) network interface parameters. Stated differently, in cases where the M-plane interface 440 terminates at the application 415, current O-RAN architectures do not enable all the information that is required/expected at the accelerator 420 to be communicated from the application 415 to the accelerator 420 via the FAPI interface.

The O-RAN entity 400 may be associated with various DMs 425, including a DM_{O-RUs} 425-a, and DM_{qDUs} 425-b. The DM_{O-RUs} 425-a may include per-RU 410 DMs 425, or DMs 425 that are associated with corresponding RUs 410. For example, DM_{O-RU} 425-a may be associated with the RU 410 illustrated in FIG. 4. In particular, the DM_{O-RU} 425-a may include or define parameters associated with communications between the RU 410 and the accelerator 420 of the DU 405. As shown in FIG. 4, the application 415 may be configured to reflect or locally cache at least a portion of the DM_{O-RU} 425-a. Open parameters of DM_{O-RU} 425-a may be documented in the O-RAN QG4 M-plane specification, and additional proprietary parameters may exist. The DM_{qDU} 425-b may include a DM 425 of HiPHY parameters associated with entities outside of the HiPHY (e.g., application 415 or beyond).

As will be described in further detail herein, some aspects of the present disclosure are directed to interfaces 435 (e.g., P9 interface 435-c and P10 interface 435-d) between the application 415 and the accelerator 420 that enable the exchange of DM_{O-RU} 425-a, and DM_{qDU} 425-b between the respective components. In particular, as shown in FIG. 4, some aspects of the present disclosure are directed to a P9 interface 435-c for accessing DM_{O-RU} 425-a (e.g., convey DM_{O-RU} 425-a from the accelerator 420 to the application 415), and a P10 interface 435-d that is configured for accessing DM_{qDu} 425-b (e.g., convey DM_{qDU} 425-b from the application 415 to the accelerator 420).

In other words, aspects of the present disclosure support communications between the application 415 and the accelerator 420 which enable the respective components to perform read/write operations associated with DMs 425 hosted at the respective components (e.g., via the P9 and P10 interfaces 435).

Aspects of the present disclosure are directed to techniques and signaling that enable the M-plane interface 440 between the DU 405 and the RU 410 to be terminated at the application 415 of the DU 405, as shown in FIG. 4. In particular, aspects of the present disclosure are directed to signaling that supports the exchange of context information between the application 415 and the accelerator 420 via the FAPI (e.g., P9 interface 435-c, P10 interface 435-d) to enable efficient communication of DMs 425 between the application 415 and the accelerator 420.

For example, referring to the O-RAN entity 400, the application 415 and the accelerator 420 may communicate messages with one another indicating an exchange configuration (e.g., P5 PARAM/CONFIG exchange) for exchanging information associated with the DMs 425 between the application 415 and the accelerator 420. In some aspects, the exchange configuration may include one or more rules, conditions, or both, for modifying DMs associated with communications between the accelerator 420 and the RU 410. In other words, as will be described in further detail herein, parameters (e.g., “<param>”) of the exchange configuration may include rules or conditions for changing or modifying YANG parameters. In some aspects, the exchange configuration may be communicated via one or more interfaces between the application 415 and the accelerator 420 (e.g., P5 interface 435-a, P19 interface 435-b, P9 interface 435-c, P10 interface 435-d).

In some aspects, the application 415 may obtain (e.g., receive, acquire) a message including context information for communications between the accelerator 420 and the RU 410 (e.g., message indicating “get<root(s) of interest to qDU>”). For example, the application 415 may obtain or receive the context information from the accelerator 420 via one or more interfaces between the application 415 and the accelerator 420, such as the P9 interface 435-c. Additionally, or alternatively, the application 415 may receive the context information from another entity or component of the DU 505.

The context information may indicate one or more parameters or characteristics associated with communications between the accelerator 420 and the RU 410. In particular, in some implementations, the context information may be exchanged between the accelerator 420 and the application 415 via the P9 interface 435-c. In this regard, the P9 interface 435-a between the application 415 and the accelerator 420 may enable efficient access and exchange of DM_{O-RUs} 425-a between the respective devices. In other words, the P8 interface 435-c may provide transparent access to DM_{O-RUs} 425-a to the application 415 and accelerator 420 (HiPHY) interface. The P9 interface 435-c may support various operations associated with DMs 425, including “read” operations, “write” operations, other NETCONF or RESTCONF operations, or any combination thereof. In some implementations, the context information may exhibit the format illustrated in Table 1 below:

TABLE 1
Context Information (P9 Interface)
P9 Interface
Operations
Message Exchange Pattern

| | |
|---|---|
| Header | PNF ID (QDU ID) |
| | PHY ID |
| | O-RU ID |
| | Application ID |

Transport (e.g., TCP, IP, PCIe, MHI, etc.)

As shown in Table 1, the context information may include, but is not limited to, an identifier associated with the accelerator 420 (e.g., PNF ID (QDU ID)), a carrier associated with the RU 410 (e.g., PHY ID), an identifier associated with the RU 410 (e.g., O-RU ID), a MAC identifier associated with the application 415 (e.g., application ID), and the like.

In some implementations, the context information may be associated with multiple carriers, multiple RUs 410, multiple applications 415, multiple accelerators, or any combination thereof. In other words, the context information may include or indicate a set of carriers associated with the DM used for communications between the accelerator 420 and the RU 410, a set of IDs associated with a set of RUs 410, a set of MAC IDs associated with a set of applications 415, or any combination thereof.

In other words, techniques described herein may enable DMO-RU 425-a subset(s) to be associated with a HiPHY carrier (e.g., DMO-RUs 425-a transactions may be labeled with a PHY ID, which identifies a carrier). In some cases, a subset of DMO-RUs 425-a accessed by a PHY-specific transaction may be relevant to the PHY layer (e.g., Tx/Rx antenna, antenna-carriers, eAxC assignments, etc.). Additionally, or alternatively, techniques described herein may enable DMO-RU 425-a subset(s) to be common access multiple carriers. In other words, aspects of the present disclosure may support non-carrier-specific data on timing windows and/or Tx antennas that are common to multiple carriers. In some cases, a special or reserved PHY ID value (e.g., “0”) may be used to indicate whether a requested DMO-RU 425-a is associated with multiple carriers.

Additionally, aspects of the present disclosure may enable DM_{O-RUs} 425-a to be associated with one or more O-RU-related identifiers. In other words, a single DM_{O-RU} 425-a may apply to one or multiple RUs 410. For example, an O-RU ID, a NETCONF session, or another identifier that points to an O-RU context or sub-context may be used in the context information to indicate applicable RUs 410. Additionally, or alternatively, the DM_{O-RUs} 425-a may apply to specific carriers or antenna panels at the applicable RUs 410. For example, the context information may indicate applicable antenna panels in different O-RUs 410 for a single PHY layer (e.g., mTRP support).

Moreover, aspects of the present disclosure may enable multiple applications 415 to access DM_{O-RUs} 425-a. In other words, DM_{O-RUs} 425-a may be non-application specific, or application agnostic. In this regard, the context information illustrated in Table 1 may indicate one or more applications 415 associated with the requested DM_{O-RUs} 425-a, such as via operator or application IDs when multiple operators share a SoC. Similarly, the context information may indicate applicable applications 415 by indicating a vDU ID or S-DU ID. Further, aspects of the present disclosure may enable a message exchange service and an operation layer to access DM_{O-RUs} 425-a. For example, in the context of operations, the application 415 and the accelerator 420 may perform read/write operations to access DM_{O-RUs} 425-a (e.g., similar to NETCONF get or edit-config commands). By way of another example, in the context of a message exchange service, aspects of the present disclosure may support operations such as request/reply association, error reporting, or additional procedures (e.g., similar to NECONF rpc).

In this regard, the P9 interface 435-a described herein may facilitate message exchange service and operations. For example, the P9 interface 435-c may facilitate a message exchange pattern for data access (e.g., read/write/schema/etc. operations and associated replies), error conditions (e.g., abnormal replies, abnormal errors), and other commands (e.g., other commands that allow additional transactions, such as antenna calibration commands).

Further, the P9 interface 435-c may facilitate other data access operations, such as read operations, write operations, and schema operations. Read operations may exhibit the form “read: get <param>,” and may be issued by the qDU (e.g., accelerator 420) and may include a corresponding data reply, similar to NETCONF get and/or get-config commands. In such cases, <param> may identifies the YANG module and/or node(s) to be signaled by the application 415, and may identify that the application 415 provisions to the accelerator 420. Additionally, or alternatively, read commands may be characterized by “set <param>” which is issued by the application 415, and includes a potential success reply.

Write operations may exhibit the form “write: edit-config,” and may be issued by the qDU (e.g., accelerator 420 and may include a corresponding successful outcome reply, similar to NETCONF edit-config commands. Additionally, or alternatively, write commands may be characterized by “extract <param>,” and may be issued by the application 415 and may include a corresponding data reply to be modified in DM_{O-RUs} 425. In the context of write commands, <param> may identify the data that the application 415 expects/allows the accelerator 420 (e.g., qDU) to potentially modify (may be indicated via the exchange configuration).

Similarly, schema operations may exhibit the form “schema: get-schema,” and may be issued by the qDU (e.g., accelerator 420) and may include a corresponding schema reply, similar to NETCONF get-schema commands. Additionally, or alternatively, write commands may be characterized by “set-schema <param>” used by the application 415 and may include a possible success reply. In the context of schema commands, <param> may identify the schema that the application 415 notifies to the accelerator 420.

Other commands or data access operations that may be facilitated by the P9 interface 435-c may include, but are not limited to, locking/unlocking, support for multiple data sets, deletion, session notification, notification of metrics or notification of pertinent DM_{O-RUs} 425, leaf/node changes, and the like.

In some aspects, the application 415 may be configured to utilize the context information (as illustrated in Table 1) to obtain (e.g., retrieve, receive, acquire) configuration information associated with a DM 425 for communications between the accelerator 420 and the RU 410. In some cases, the application 415 may obtain the configuration information by querying the RU 410 (e.g., via the M-plane interface 440).

For example, in some implementations, the application 415 may provide or output (e.g., transmit) a request for the configuration information associated with a DM 425 to the RU 410. For instance, the application 415 may output a request to the RU 410 via the M-plane interface 440 between the application 415 and the RU 410. The application 415 may transmit the request based on obtaining the context information at 530, or both. For instance, in some cases, the request may indicate the context information obtained from the accelerator 420 or some other component/entity. Continuing with the same example, the application 415 may receive or obtain the configuration information from the RU 410 based on (e.g., in response to) the request. In some implementations, the application 415 may receive or obtain the configuration information via the M-plane interface 440 between the application 415 and the RU 410. In some aspects, the application 415 may store or save the received configuration information in memory or cache at (or accessible by) the application 415.

Additionally, or alternatively, the application 415 may obtain the configuration information by retrieving the configuration information from a memory or cache (e.g., storage) at the application 415. For example, the application 415 may retrieve the configuration information for the DM 425 from a cache or memory maintained at (or accessible by) the application 415. The application 415 may retrieve the configuration information based on the context information. In some implementations, the application 415 may retrieve the configuration information from cache in lieu of querying the RU 410.

In some aspects, the accelerator 420 may use the configuration information to provision a DM that the accelerator 420 hosts. For instance, the configuration information associated with the DM_{O-RU} 425-a may include or be associated with one or more parameters or characteristics associated with communications between the accelerator 420 and the RU 410. For example, in some cases, the configuration information may include a capability associated with the RU 410, parameters associated with communications performed by the RU 410 (e.g., supported carriers), and the like.

In some aspects, the application 415 may provide (e.g., output, transmit) a message including the received configuration information to the accelerator 420 (e.g., message indicating (e.g., message provisioning YANG data of “<root(s) of interest to qDU>”). In some aspects, the configuration information may be communicated via one or more interfaces between the application 415 and the accelerator 420, such as via the P9 interface 435-c. In some aspects, the P9 interface 435-c may enable stringent simplifications that enable the application 415 to signal cached YANG data files to each PHY, and extract the leaves to modify from P5 parameters.

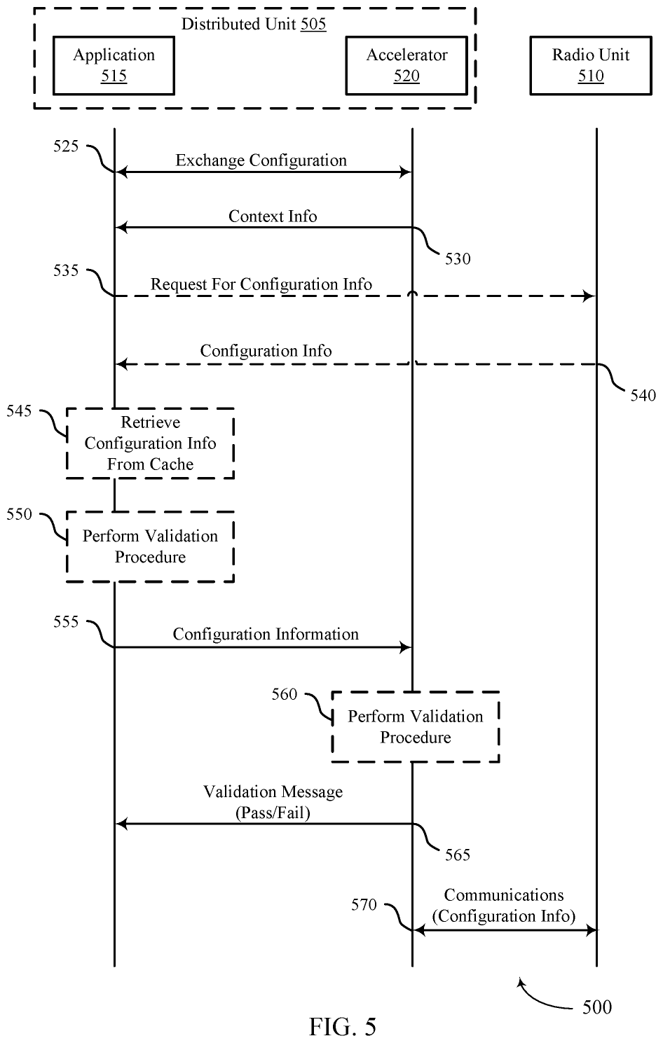

In some implementations, as will be described in further detail with respect to FIG. 5, the application 415, the accelerator 420, or both, may be configured to validate received configuration parameters. The application 415 and/or the accelerator 420 may perform the validation procedure to determine whether the received configuration information includes expected parameters or characteristics associated with the communications between the accelerator 420 and the RU 410. In some aspects, the respective components may perform the validation procedure based on (e.g., using) the context information received at 530. In other words, the application 415, and/or the accelerator 420 may be configured to validate received DM_{O-RUs} 425-a. In some cases, the application 415 may be configured to validate received configuration information prior to providing the configuration information to the accelerator 420 (e.g., only provide validated configuration information to the accelerator 420).

As will be described in further detail herein, in the event that configuration information received at the application 415 and/or accelerator 420 fails a validation procedure (e.g., fails a write validation), the respective components may be configured to utilize various methods or implementations to modify or obtain additional configuration information that may pass validation.

According to a first implementation for handling validation failure, the accelerator 420 (e.g., client of the P9 interface 435-c) may re-try transmitting context information and/or retrieving configuration information up to a threshold or maximum quantity of attempts, and/or for a time duration until timeout (where the threshold/maximum quantity of attempts and/or time duration may be signaled, hard-coded, or capability-based). According to a second implementation for handling validation failure, the accelerator 420 may store the validation failure in memory, and use an edits configuration (e.g., the exchange configuration) differently based on stored validation failure. According to a third implementation for handling validation failure, the application 415 (e.g., server of the P9 interface 435-c) may store the validation failure in memory and inform the accelerator 420 to re-attempt the write in a different manner or fashion (e.g., inform the accelerator 420 to re-attempt the write in a more conservative manner, for example, by providing more conservative context information). In other words, in accordance with the third implementation, the application 415 may instruct the accelerator 420 to modify the context information that will be used to retrieve configuration information for DM_{O-RUs} 425-a. Additionally, or alternatively, the application 415 may modify the configuration information and/or DM_{O-RU} 425-a to restrict the edit operations that are available to the accelerator 420, and/or provide the modified/edited configuration information and/or modified DM_{O-RU}425-a to the accelerator 420.

For example, in cases where the validation procedure fails (e.g., the received configuration information fails the validation procedure), the application 415 and/or accelerator 420 may modify the received configuration information, retrieve new configuration information, or both. For instance, in some cases, the application 415 and/or accelerator 420 may modify one or more parameters of the configuration information in accordance with the exchange configuration. In particular, the application 415 and/or accelerator 420 may modify one or more parameters of the configuration information in accordance with the one or more parameters or rules for modifying DMs 425 associated with communications between the accelerator 420 and the RU 410, as defined by the exchange configuration. In this regard, in the event of a failure of the validation procedure, the application 415 and/or accelerator 420 may generate a modified version of the configuration information.

In cases where the application 415 and/or the accelerator 420 modify the received configuration information for the DM_{O-RU} 425-a, the respective components may inform the other components of the modification (e.g., via the P5 interface 435-a, or other interface/API). In some cases, the indication of the modification may include a short list of modified YANG parameters (e.g., the indication of the modification may not be in YANG format). For example, in cases where the accelerator 420 modifies a single parameter of the received configuration information, the accelerator 420 may indicate the single modified parameter to the application 415 (as opposed to returning the full configuration information with the single modified parameter).

By way of another example, in some implementations, in the event of a failure of the validation procedure, the application 415 may retrieve different configuration information from cache/memory, as shown at 545. Moreover, in other implementations, the application 415 may re-query the RU 410 for new or different configuration information (e.g., via the M-plane interface 440). In such cases, the application 415 may indicate the failed validation procedure to the RU 410 so that the RU 410 may provide different or modified configuration information (via the M-plane interface 440) that will pass the validation procedure.

In additional or alternative implementations, in the event of a failure of the validation procedure, the application 415 may indicate the failure of the validation procedure to the accelerator 420 so that the accelerator can provide new or different context information that may be used to obtain new or different configuration information (e.g., instruct the accelerator 420 to re-attempt the write with more conservative context information). For example, the application 415 may identify a failure of the validation procedure, and may provide a message to the accelerator 420 indicating the failure, and instructing the accelerator 420 to modify the context information and/or provide new context information. In this example, the application 415 may receive additional context information from the accelerator 420, and may utilize the additional context information to obtain additional configuration information (e.g., by querying the RU 410 via the M-plane interface 440, or by retrieving additional context information from cache). Further, once the additional context information is obtained, the application 415 may perform the validation procedure on the additional configuration information.

In cases where the accelerator 420 is configured to perform a validation procedure on the configuration information received from the application 415, the accelerator 420 may provide a message to the application 415 indicating a result of the validation procedure (e.g., validation pass/fail). In other words, the accelerator 420 may indicate whether or not the received configuration information has been validated or not. Subsequently, the accelerator 420 may communicate with the RU 410 in accordance with the received configuration information for the DM_{O-RU} 425-a. For example, in some cases, the accelerator 420 may configure one or more parameters at the RU 410 in accordance with the configuration information.

In some aspects, the accelerator 420 may be configured to maintain received configuration information (e.g., configuration information for DM_{O-RU} 425-a) for some time interval, until the configuration information is overwritten, until some event or condition, or any combination thereof. In other words, the accelerator 420 may utilize different implementations for determining whether DMs 425 received from the application 415 are valid or invalid, and for maintaining and discarding such DMs 425. In particular, an O-RU 410 context status can be maintained (at the accelerator 420) for each O-RU 410 context, where the O-RU 410 context status may be driven or controlled by explicit API calls (e.g., a new operation or transaction, an out-of-band call (via FAPI P5), etc.).

As may be appreciated by the foregoing description, various operations (e.g., read/write operations) may be initiated or triggered by the application 415, the accelerator 420 (e.g., HiPHY, qDU), or both. The steps of the various operations may be different based on where the respective operation is initiated.

For example, as described previously herein, in the context of a read operation triggered by the accelerator 420 (e.g., q-DU-triggered read), the read operation may include the following steps: (1) application 415 configures PHY (FAPI CONFIG), (2) application 415 determines how to configure O-RU 410, to serve the carrier intended for PHY, (3) application receives PHY P9 get request (e.g., receives context information via P9 interface 435-c), (4) application either translates the PHY request to a NETCONF get (or get-config) towards O-RU 410 server, or retrieves the configuration information from its local cache, (5) application sends the configuration information/YANG model (or a subset thereof) pertinent to the request to qDU/accelerator 420, and (6) application 415 receives FAPI CONFIG.response (e.g., validation pass/fail response), which may be successful (MSG_OK) or failed (new status code MSG_VALIDATION_FAILURE). Optionally, the application 415 may skip nodes that it deems irrelevant to the PHY. In the context of a read operation initiated by the application 415 (e.g., application-initiated read), the read operation may include steps 1, 2, 4, and 5 from above (e.g., application 415 does not receive context information and/or validation response when the application 415 initiates the read).

By way of another example, in the context of a write operation initiated by the accelerator 420 (e.g., qDU-initiated write), the write operation may include the following steps: (1) application receives edit-config from O-RU 410, (2) application 415 determines whether the edit-config can be allowed, (3) application 415 either locally caches the edit-config, or directly issues an equivalent edit-config to O-RU 410, and (4) a successful reply, if any, may reflect local caching, successful write to O-RU 410, or successful write to candidate dataset. Comparatively, in the context of a write operation initiated by the application 415 (e.g., app-initiated write), the write operation may include the following steps: (1) application 415 determines which edit-configs are allowed, (2) application 415 sends the writeable YANG model (e.g., configuration information) to accelerator 420/qDU, (3) accelerator 420/qDU replies with potentially new values in the configuration information/YANG model, (4) application 415 determines whether the edit-config can be allowed, (5) application 415 either locally caches the edit-config, or directly issues an equivalent edit-config to O-RU 410, and (6) a successful reply, if any, may reflect local caching, successful write to O-RU 410, or successful write to candidate dataset.

In some implementations, the accelerator 420 may be configured to maintain a session with the application 415 (e.g., maintain ongoing communications), and received configuration information for DM_{O-RU} 425-a may be valid and consistent across the application 415 and HiPHY (accelerator 420) as long as the session is maintained. That is, a validity of a DM_{O-RU} 425-a may be determined by valid={PHY CONFIG.request, PHY CONFIG, or PHY RUNNING}, and invalid={PHY IDLE}, where such logic extends to PHY ID 0 as a special PHY.

In the context of a read filter (e.g., read operation), a full read filter may be associated with xpath and subtree filters. Simplifications to such read techniques may include (1) support only subtree filter, (2) support only root (module) subtree filter, and (3) no filter. In the context of write operations, a full write operation (full support, merge) may include create, delete, replace, remove, merge, or any combination thereof. A simplification to such write techniques may include signal writeable values in explicit parameters outside the YANG exchanges (e.g., compression values to be used, per eAxC). In the context of schema operations, no support may imply or be associated with support for a basic schema/YANG library, where the application 415 performs translation to the right schema for the NETCONF O-RU transactions, in case of backward compatibility issues.

As noted previously herein, the application 415 and accelerator 420 may be configured to utilize different mechanisms for error handling (e.g., different mechanisms for handling validation failure). In some cases, the components may simplify such error handling by handling a single error “operation-failed.” For full error handling/validation failure, the components may implement an operation that indicates validity failure on the qDU/accelerator 420 side (e.g., application 415 can use to fall back to a basic model upon the next get request). Additionally, or alternatively, the components may support new stats code to PHY_CONFIG.reply (e.g., “YANG validation failure”). Other simplifications may include no read validations, support for writeable-running data store, and no support for notifications and/or locks.

Some aspects of the present disclosure may support various techniques or simplifications for writeable parameters of configuration information associated with DM_{O-RU} 425-a. For example, a priority of coupling choices may be used to establish a preferred order of coupling priorities (e.g., normal, frequency and time, frequency and time with priorities, frequency and time with priorities optimized), where the list can have dependency on section type. Other writeable parameters may include priority of downlink, uplink, and bandwidth I/Q compression type (e.g., dynamic, static, possibly by section type), priority of uplink I/Q compression methods (e.g., list for dynamic, choice for static), preferred I/Q weights, and the like. In some implementations, simplifications for writeable parameters may be made for each eAxC-ID (e.g., coupling, and compression type, compression method, and/or I/Q weight for each uplink/downlink bandwidth).

Techniques described herein may enable the M-plane interface 440 between the DU 405 and the RU 410 of the O-RAN entity 400 to be terminated at an application 415 of the DU 405, as opposed to an accelerator 420 of the DU405. In particular, techniques of the present disclosure support signaling between the application 415 and the accelerator 420 of the DU 405 which enables the M-plane interface 440 to be terminated at the application 415. By enabling the M-plane interface 440 to be terminated at the application 415, rather than the accelerator 420, techniques described herein may reduce or eliminate the need for the accelerator 420 to relay DMs 425 received from the RU 410 to the application 415, thereby reducing signaling and processing performed at the DU 405. Additionally, by enabling the M-plane interface 440 to be terminated at the application 415, techniques described herein may reduce the amount of processing operations that that are duplicated across both the application 415 and the accelerator 420, thereby reducing power consumption and complexity of the DU 405 and O-RAN entity 400.

FIG. 5 illustrates an example of a process flow 500 that supports techniques for application and accelerator communications of a DU in accordance with one or more aspects of the present disclosure. In some examples, aspects of the process flow 500 may implement, or be implemented by, aspects of the wireless communications system 100, the network architecture 200, the O-RAN architecture 300, the O-RAN entity 400, or any combination thereof.

The process flow 500 may include a DU 505 and an RU 510 of an O-RAN entity, which may be examples of DUs, RUs, and O-RAN entities described with reference to FIGS. 1-4. For example, the DU 505 and the RU 510 illustrated in FIG. 5 may be examples of the DU 405 and the RU 410, respectively, as illustrated in FIG. 4.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 525, the application 515 and the accelerator 520 may communicate messages with one another indicating an exchange configuration for exchanging information associated with the data model between the application 515 and the accelerator 520. In some aspects, the exchange configuration may include one or more rules, conditions, or both, for modifying DMs (e.g., DM_{O-RUs} 425-a illustrated in FIG. 4) associated with communications between the accelerator 520 and the RU 510. In some aspects, the exchange configuration may be communicated via one or more interfaces between the application 515 and the accelerator 520 (e.g., P5, P19, P9, P10 interfaces).

At 530, the application 515 may obtain (e.g., receive, acquire) context information for communications between the accelerator 520 and the RU 510 communicatively coupled to the DU 505. For example, as shown in FIG. 4, the application 515 may obtain or receive the context information from the accelerator 520. In some aspects, the application 515 may obtain (and the accelerator 520 may provide) the context information at 530 based on obtaining/providing the exchange configuration at 525.

In some aspects, the context information may be communicated via one or more interfaces between the application 515 and the accelerator 520 (e.g., P5, P19, P9, P10 interfaces). Additionally, or alternatively, the application 515 may receive the context information from another entity or component of the DU 505.

The context information may indicate one or more parameters or characteristics associated with communications between the accelerator 520 and the RU 510. In particular, in some implementations, the context information may be exchanged between the accelerator 520 and the application 515 via the P9 interface 435-c illustrated in FIG. 4, and may exhibit the format illustrated in Table 1 above. For example, as shown in Table 1, the context information may include, but is not limited to, an identifier associated with the accelerator 520 (e.g., PNF ID (QDU ID)), a carrier associated with the RU 510 (e.g., PHY ID), an identifier associated with the RU 510 (e.g., O-RU ID), a MAC identifier associated with the application 515 (e.g., application ID), and the like.

Moreover, in some implementations, the context information may be associated with multiple carriers, multiple RUs 510, multiple applications 515, multiple accelerators, or any combination thereof. In other words, the context information may include or indicate a set of carriers associated with the DM used for communications between the accelerator 520 and the RU 510, a set of IDs associated with a set of RUs 510, a set of MAC IDs associated with a set of applications 515, or any combination thereof.

The application 515 may be configured to utilize the context information received at 530 to obtain (e.g., retrieve, receive, acquire) configuration information associated with a DM (e.g., DM_{O-RU} 425-a) for communications between the accelerator 520 and the RU 510. In some cases, the application 515 may obtain the configuration information by querying the RU 510 (e.g., via an M-plane interface 440), as shown in steps 535 and 540. Additionally, or alternatively, the application 515 may obtain the configuration information by retrieving the configuration information from a memory or cache at the application 515, as shown in step 545. The various methods for obtaining the configuration information based on the context information will be described in turn.

At 535, the application 515 may provide or output (e.g., transmit) a request for the configuration information (e.g., DM_{O-RU} 425-a) to the RU 510. For example, as illustrated in FIG. 4, the application 515 may output a request to the RU 510 via an M-plane interface between the application 515 and the RU 510. The application 515 may transmit the request at 535 based on obtaining/providing the exchange configuration at 525, obtaining the context information at 530, or both. For example, in some cases, the request may indicate the context information which was received at 530.

At 540, the application 515 may receive or obtain the configuration (e.g., DM_{O-RU} 425-a) from the RU 510. In particular, the application 515 may receive the configuration information based on (e.g., in response to) the request at 535. In some implementations, the application 515 may receive or obtain the configuration information at 540 via the M-plane interface between the application 515 and the RU 510. In some aspects, the application 515 may store or save the received configuration information in memory or cache at (or accessible by) the application 515.

The configuration information may include or be associated with one or more parameters or characteristics associated with communications between the accelerator 520 and the RU 510. For example, in some cases, the configuration information may include a capability associated with the RU 510, parameters associated with communications performed by the RU 510 (e.g., supported carriers), and the like.

At 545, the application 515 may retrieve the configuration information from a cache or memory maintained at (or accessible by) the application 515. The application 515 may retrieve the configuration information based on the context information received at 530. In some implementations, the application 515 may retrieve the configuration information from cache in lieu of querying the RU 510 at 535 and 540. In this regard, the querying process illustrated at 535 and 540, and the retrieval process illustrated at 545, may be viewed as alternative methods or implementations for obtaining the configuration information based on the received context information.

At 550, the application 515 may perform a validation procedure on the obtained configuration information. The application 515 may perform the validation procedure to determine whether the received configuration information includes expected parameters or characteristics associated with the communications between the accelerator 520 and the RU 510. In some aspects, the application 515 may perform the validation procedure based on (e.g., using) the context information received at 530.

In cases where the validation procedure fails (e.g., the received configuration information fails the validation procedure), the application 515 may modify the received configuration information, retrieve new configuration information, or both. For example, in some cases, the application 515 may modify one or more parameters of the configuration information in accordance with the exchange configuration obtained/provided at 525. In particular, the application 515 may modify one or more parameters of the configuration information in accordance with the one or more parameters or rules for modifying DMs associated with communications between the accelerator 520 and the RU 510, as defined by the exchange configuration. In this regard, in the event of a failure of the validation procedure, the application 515 may generate a modified version of the configuration information that may be provided to the accelerator 520.

In additional or alternative implementations, in the event of a failure of the validation procedure, the application 515 may retrieve different configuration information from cache/memory, as shown at 545. Moreover, in other implementations, the application 515 may re-query the RU 510 for new or different configuration information, as shown at 535 and 540. In such cases, the application 515 may indicate the failed validation procedure to the RU 510 so that the RU 510 may provide different or modified configuration information that will pass the validation procedure at 550.

In additional or alternative implementations, in the event of a failure of the validation procedure, the application 515 may indicate the failure of the validation procedure to the accelerator 520 so that the accelerator can provide new or different context information that may be used to obtain new or different configuration information. For example, the application 515 may identify a failure of the validation procedure at 550, and may provide a message to the accelerator indicating the failure, and instructing the accelerator 520 to modify the context information and/or provide new context information. In this example, the application 515 may receive additional context information from the accelerator 520, and may utilize the additional context information to obtain additional configuration information (e.g., via querying the RU 510 at 535 and 540, or by retrieving additional context information from cache at 545). Further, once the additional configuration information is obtained, the application 515 may perform the validation procedure at 550 on the additional configuration information.

At 555, the application 515 may provide (e.g., output, transmit) the configuration information to the accelerator 520. In some aspects, the configuration information may be communicated via one or more interfaces between the application 515 and the accelerator 520 (e.g., P5, P19, P9, P10 interfaces).

In some aspects, the application 515 may provide the configuration information to the accelerator 520 at 555 based on obtaining/providing the exchange configuration at 525, obtaining the context information at 530, obtaining the configuration information at 535, 540, and/or 545, performing the validation procedure at 550, or any combination thereof. For example, the application 515 may provide the configuration information at 555 based on the configuration information passing the validation procedure at 550.

By way of another example, in cases where original configuration information received at 540 and/or 545 fails the validation procedure, the application 515 may obtain additional configuration information, where the additional configuration may pass the validation procedure at 550 and subsequently be provided to the accelerator 520. In additional or alternative implementations, the application 515 may not be configured to perform a validation procedure, as shown at 550. In such cases, the application 515 may provide the configuration information to the accelerator 520 without performing the validation procedure (e.g., whether or not the obtained configuration information would pass a validation procedure).

At 560, the accelerator 520 may perform a validation procedure on the obtained configuration information. The accelerator 520 may perform the validation procedure to determine whether the received configuration information includes expected parameters or characteristics associated with the communications between the accelerator 520 and the RU 510. As noted previously herein with respect to the validation procedure at 550, the accelerator 520 may perform the validation procedure based on (e.g., using) the context information provided at 530.

At 565, the accelerator 520 may provide, to the application 515, a message indicating a result of the validation procedure performed at 560 (e.g., validation pass/fail). In other words, the accelerator 520 may indicate whether or not the received configuration information has been validated or not.

In the event of a validation failure, the accelerator 520 may be configured to utilize one or more methods or implementations to obtain new or modified configuration information, as described previously herein with respect to the validation procedure at 555. For example, the accelerator 520 may be configured to modify one or more parameters of the configuration information (e.g., in accordance with the exchange configuration), transmit additional (e.g., modified) context information to the application 515 that may be used for obtaining additional configuration information, and the like. In this regard, any implementations for obtaining additional/modified configuration information in the event of a validation failure that were described in the context of the validation procedure at 550 may also be applicable to the validation procedure at 560, unless noted otherwise herein.

At 570, the accelerator 520 may communicate with the RU 510 in accordance with the configuration information. For example, in some cases, the accelerator 520 may configure one or more parameters at the RU 510 in accordance with the configuration information. In some aspects, the accelerator 520 may communicate with the RU 510 based on validating the configuration information at 560, based on obtaining additional configuration information that passes validation at 560, or both. Moreover, the accelerator 520 may perform the communications at 570 based on transmitting the message at 565 which indicates the result of the validation procedure.

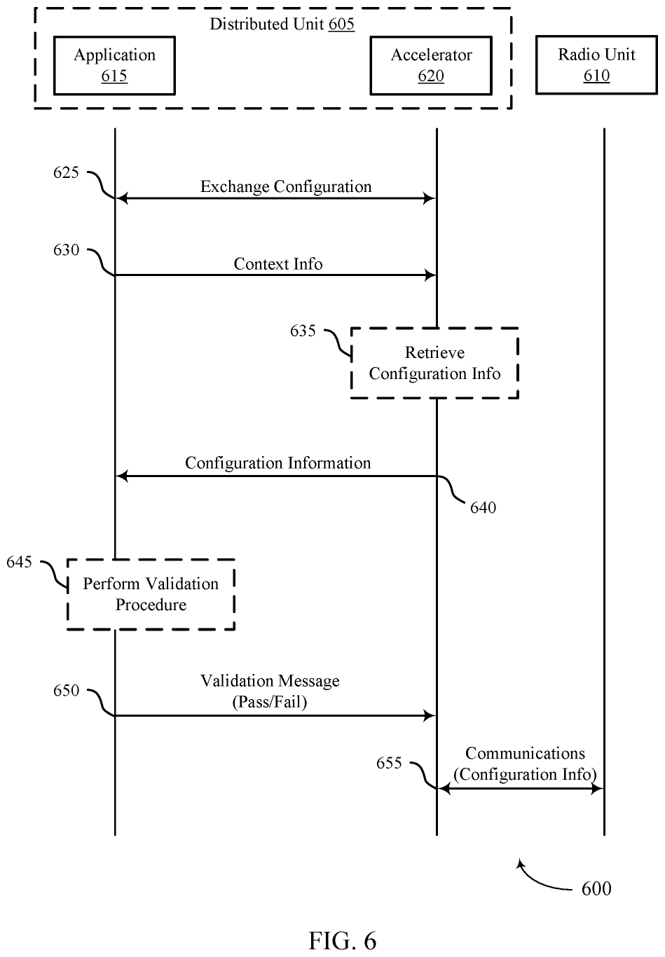

FIG. 6 illustrates an example of a process flow 600 that supports techniques for application and accelerator communications of a DU in accordance with one or more aspects of the present disclosure. In some examples, aspects of the process flow 600 may implement, or be implemented by, aspects of the wireless communications system 100, the network architecture 200, the O-RAN architecture 300, the O-RAN entity 400, the process flow 500, or any combination thereof.

The process flow 600 may include a DU 605 and an RU 610 of an O-RAN entity, which may be examples of DUs, RUs, and O-RAN entities described with reference to FIGS. 1-4. For example, the DU 605 and the RU 610 illustrated in FIG. 5 may be examples of the DU 405 and the RU 410, respectively, as illustrated in FIG. 4.

In some examples, the operations illustrated in process flow 600 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 625, the application 615 and the accelerator 620 may communicate messages with one another indicating an exchange configuration for exchanging information associated with the data model between the application 615 and the accelerator 620. In some aspects, the exchange configuration may include one or more rules, conditions, or both, for modifying DMs (e.g., DM_{O-RUs} 425-a and/or DM_{qDUs} 425-b illustrated in FIG. 4). In some aspects, the exchange configuration may be communicated via one or more interfaces between the application 615 and the accelerator 620 (e.g., P5, P19, P9, P10 interfaces).

At 630, the accelerator 620 may obtain (e.g., receive, acquire) context information for a DM from the accelerator 620. In some aspects, the accelerator 620 may obtain (and the application 615 may provide) the context information at 630 based on obtaining/providing the exchange configuration at 625.

In some aspects, the context information may be communicated via one or more interfaces between the application 615 and the accelerator 620 (e.g., P5, P19, P9, P10 interfaces). Additionally, or alternatively, the application 615 may receive the context information from another entity or component of the DU 605.

The context information may be exchanged between the accelerator 620 and the application 615 via the P9 interface 435-c illustrated in FIG. 4, and may exhibit the format illustrated in Table 1 above. For example, as shown in Table 1, the context information may include, but is not limited to, an identifier associated with the accelerator 620 (e.g., PNF ID (QDU ID)), a carrier associated with the RU 610 (e.g., PHY ID), an identifier associated with the RU 610 (e.g., O-RU ID), a MAC identifier associated with the application 615 (e.g., application ID), and the like.

Moreover, in some implementations, the context information may be associated with multiple carriers, multiple RUs 610, multiple applications 615, multiple accelerators, or any combination thereof. In other words, the context information may include or indicate a set of carriers associated with the DM used for communications between the accelerator 620 and the RU 610, a set of IDs associated with a set of RUs 610, a set of MAC IDs associated with a set of applications 615, or any combination thereof. The accelerator 620 may be configured to utilize the context information received at 630 to obtain (e.g., retrieve, receive, acquire) configuration information associated with a DM (e.g., DM_{qDU} 425-b) hosted at the accelerator 620.

At 635, the accelerator 620 may obtain or retrieve configuration information associated with a DM (e.g., DM_{qDU} 425-b) based on the received context information. For example, in some cases, the accelerator 620 may obtain the configuration information by retrieving the configuration information from a memory or cache at the accelerator 620.

At 640, the accelerator 620 may provide (e.g., output, transmit) the configuration information to the application 615. In some aspects, the configuration information may be communicated via one or more interfaces between the application 615 and the accelerator 620 (e.g., P5, P19, P9, P10 interfaces). In some aspects, the accelerator 620 may provide the configuration information to the application 615 at 640 based on obtaining/providing the exchange configuration at 625, obtaining the context information at 630, retrieving the configuration information at 635, or any combination thereof.

At 645, the application 615 may perform a validation procedure on the obtained configuration information, as described herein. The application 615 may perform the validation procedure to determine whether the received configuration information includes expected parameters or characteristics associated with the requested DM and/or the provided context information. In this regard, the application 615 may perform the validation procedure based on (e.g., using) the context information provided at 630.

At 650, the application 615 may provide, to the accelerator 620, a message indicating a result of the validation procedure performed at 645 (e.g., validation pass/fail). In other words, the application 615 may indicate whether or not the received configuration information has been validated or not.

In the event of a validation failure, the application 615 may be configured to utilize one or more methods or implementations to obtain new or modified configuration information, as described previously herein. For example, the application 615 may be configured to modify one or more parameters of the configuration information (e.g., in accordance with the exchange configuration), transmit additional (e.g., modified) context information to the accelerator 620 that may be used for obtaining additional configuration information, and the like.

At 655, the accelerator 620 may communicate with the RU 610 in accordance with the configuration information. For example, in some cases, the accelerator 620 may configure one or more parameters at the RU 610 in accordance with the configuration information.

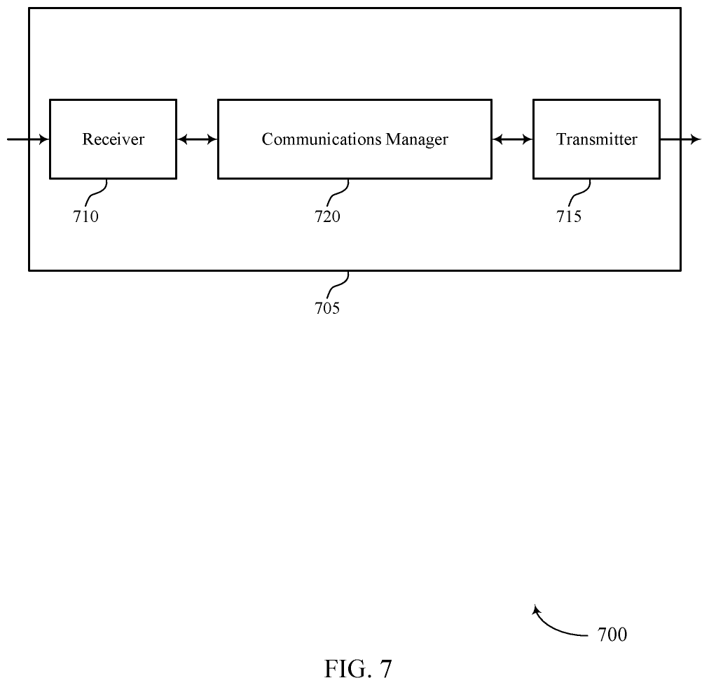

FIG. 7 shows a block diagram 700 of a device 705 that supports techniques for application and accelerator communications of a DU in accordance with one or more aspects of the present disclosure. The device 705 may be an example of aspects of a network entity 105 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations thereof or various components thereof may be examples of means for performing various aspects of techniques for application and accelerator communications of a DU as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at an application executable by a DU of a RAN in accordance with examples as disclosed herein. For example, the communications manager 720 is capable of, configured to, or operable to support a means for identifying context information including a first identifier associated with an accelerator of the DU, a second identifier associated with the application, a third identifier associated with a profile instance associated with the accelerator, a fourth identifier associated with an RU associated with the DU, or any combination thereof. The communications manager 720 is capable of, configured to, or operable to support a means for exchanging messages with the accelerator based on the identified context information.

Additionally, or alternatively, the communications manager 720 may support wireless communication at an accelerator associated with a DU of a RAN in accordance with examples as disclosed herein. For example, the communications manager 720 is capable of, configured to, or operable to support a means for identifying context information including a first identifier associated with the accelerator, a second identifier associated with an application of the DU, a third identifier associated with a profile instance associated with the accelerator, a fourth identifier associated with an RU associated with the DU, or any combination thereof. The communications manager 720 is capable of, configured to, or operable to support a means for exchanging messages with the application based on the identified context information. Additionally, or alternatively, the communications manager 720 may support wireless communication at an application executable by a DU of a RAN in accordance with examples as disclosed herein. For example, the communications manager 720 may be configured as or otherwise support a means for communicating a first message with an accelerator of the DU, the first message including context information associated with a data model hosted at the accelerator or the application. The communications manager 720 may be configured as or otherwise support a means for communicating a second message with the accelerator based on the context information, the second message including configuration information associated with the data model.

Additionally, or alternatively, the communications manager 720 may support wireless communication at an accelerator associated with a DU of a RAN in accordance with examples as disclosed herein. For example, the communications manager 720 may be configured as or otherwise support a means for communicating a first message with an application executable by the DU, the first message including context information associated with a data model hosted at the accelerator or the application. The communications manager 720 may be configured as or otherwise support a means for communicating a second message with the application based on the context information, the second message including configuration information associated with the data model.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for exchanging context information between an application and an accelerator of a DU that enables the respective components to perform read/write operations on DMs hosted at the respective components. Techniques described herein may enable the M-plane interface between a DU and an RU of an O-RAN network entity 105 to be terminated at an application of the DU, as opposed to an accelerator of the DU. In particular, techniques of the present disclosure support signaling between the application and the accelerator of the DU which enables the M-plane interface to be terminated at the application. By enabling the M-plane interface to be terminated at the application, rather than the accelerator, techniques described herein may reduce or eliminate the need for the accelerator to relay DMs received from the RU to the application, thereby reducing signaling and processing performed at the DU. Additionally, by enabling the M-plane interface to be terminated at the application, techniques described herein may reduce the amount of processing operations that that are duplicated across both the application and the accelerator, thereby reducing power consumption and complexity of the DU and O-RAN network entity 105.

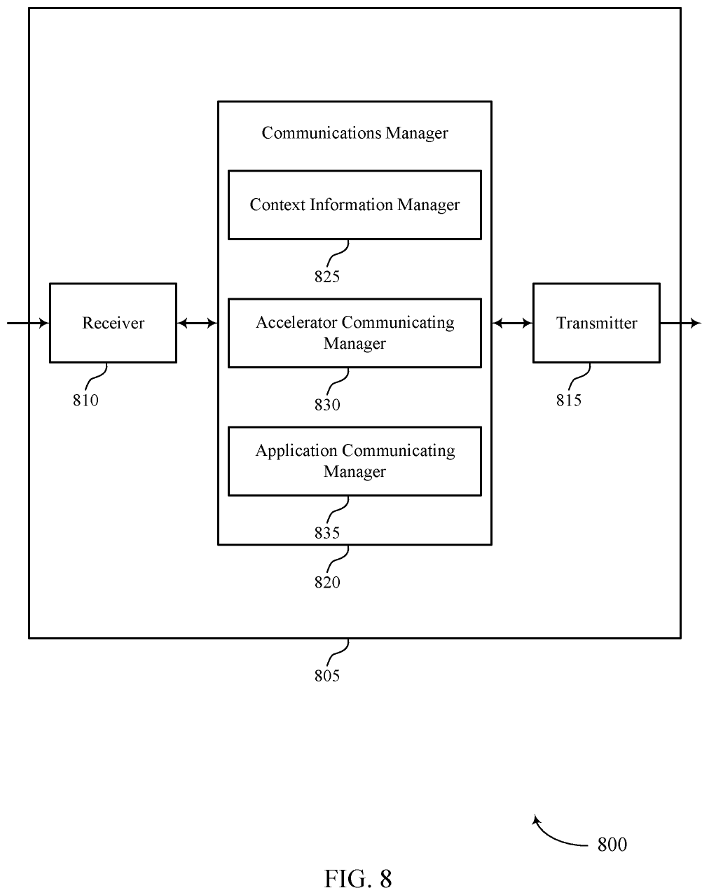

FIG. 8 shows a block diagram 800 of a device 805 that supports techniques for application and accelerator communications of a DU in accordance with one or more aspects of the present disclosure. The device 805 may be an example of aspects of a device 705 or a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of techniques for application and accelerator communications of a DU as described herein. For example, the communications manager 820 may include a context information manager 825, an accelerator communicating manager 830, an application communicating manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at an application executable by a DU of a RAN in accordance with examples as disclosed herein. The context information manager 825 is capable of, configured to, or operable to support a means for identifying context information including a first identifier associated with an accelerator of the DU, a second identifier associated with the application, a third identifier associated with a profile instance associated with the accelerator, a fourth identifier associated with an RU associated with the DU, or any combination thereof. The accelerator communicating manager 830 is capable of, configured to, or operable to support a means for exchanging messages with the accelerator based on the identified context information.

Additionally, or alternatively, the communications manager 820 may support wireless communication at an accelerator associated with a DU of a RAN in accordance with examples as disclosed herein. The context information manager 825 is capable of, configured to, or operable to support a means for identifying context information including a first identifier associated with the accelerator, a second identifier associated with an application of the DU, a third identifier associated with a profile instance associated with the accelerator, a fourth identifier associated with an RU associated with the DU, or any combination thereof. The application communicating manager 835 is capable of, configured to, or operable to support a means for exchanging messages with the application based on the identified context information. Additionally, or alternatively, the communications manager 820 may support wireless communication at an application executable by a DU of a RAN in accordance with examples as disclosed herein. The accelerator communicating manager 830 may be configured as or otherwise support a means for communicating a first message with an accelerator of the DU, the first message including context information associated with a data model hosted at the accelerator or the application. The accelerator communicating manager 830 may be configured as or otherwise support a means for communicating a second message with the accelerator based on the context information, the second message including configuration information associated with the data model.

Additionally, or alternatively, the communications manager 820 may support wireless communication at an accelerator associated with a DU of a RAN in accordance with examples as disclosed herein. The application communicating manager 835 may be configured as or otherwise support a means for communicating a first message with an application executable by the DU, the first message including context information associated with a data model hosted at the accelerator or the application. The application communicating manager 835 may be configured as or otherwise support a means for communicating a second message with the application based on the context information, the second message including configuration information associated with the data model.

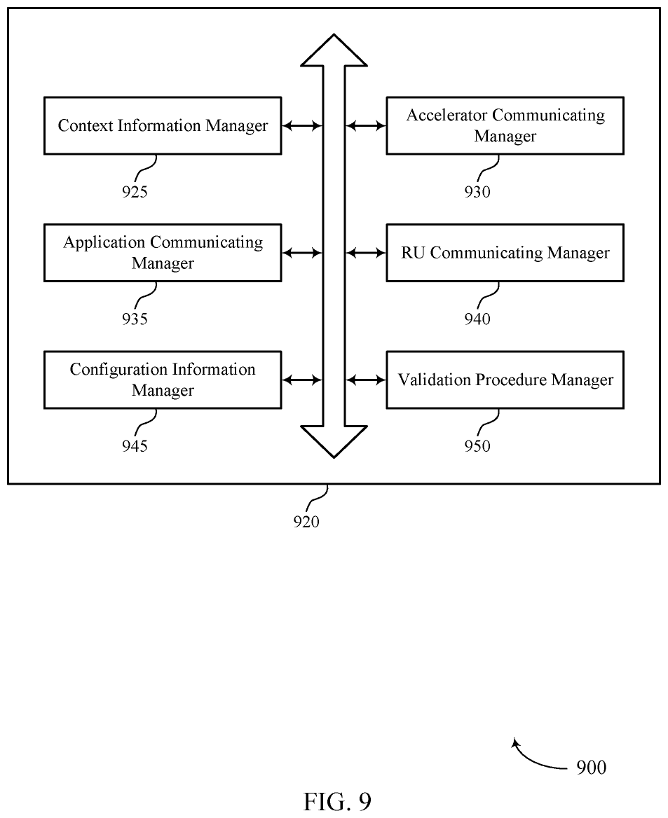

FIG. 9 shows a block diagram 900 of a communications manager 920 that supports techniques for application and accelerator communications of a DU in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for application and accelerator communications of a DU as described herein. For example, the communications manager 920 may include a context information manager 925, an accelerator communicating manager 930, an application communicating manager 935, an RU communicating manager 940, a configuration information manager 945, a validation procedure manager 950, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communication at an application executable by a DU of a RAN in accordance with examples as disclosed herein. The context information manager 925 is capable of, configured to, or operable to support a means for identifying context information including a first identifier associated with an accelerator of the DU, a second identifier associated with the application, a third identifier associated with a profile instance associated with the accelerator, a fourth identifier associated with an RU associated with the DU, or any combination thereof. The accelerator communicating manager 930 is capable of, configured to, or operable to support a means for exchanging messages with the accelerator based on the identified context information.

In some examples, to support exchanging the messages, the accelerator communicating manager 930 is capable of, configured to, or operable to support a means for providing the context information to the accelerator. In some examples, to support exchanging the messages, the accelerator communicating manager 930 is capable of, configured to, or operable to support a means for obtaining, from the accelerator based on providing the context information, information associated with a data model hosted at the accelerator.

In some examples, to support exchanging the messages, the accelerator communicating manager 930 is capable of, configured to, or operable to support a means for obtaining the context information from the accelerator. In some examples, to support exchanging the messages, the accelerator communicating manager 930 is capable of, configured to, or operable to support a means for providing, to the accelerator based on obtaining the context information, information associated with a data model for communications between the accelerator and the RU associated with the DU.

In some examples, the RU communicating manager 940 is capable of, configured to, or operable to support a means for providing, to the RU via an interface between the application and the RU, a request for the information. In some examples, the RU communicating manager 940 is capable of, configured to, or operable to support a means for obtaining the information from the RU via the interface and in response to the request. In some examples, the information obtained from the RU is further conveyed to the accelerator via a second interface between the application and the accelerator.

In some examples, the accelerator communicating manager 930 is capable of, configured to, or operable to support a means for obtaining, from the accelerator based on providing the information, a first message indicating a result of a validation procedure associated with the information.

In some examples, the first message indicates a failure of the validation procedure, and the accelerator communicating manager 930 is capable of, configured to, or operable to support a means for providing, to the accelerator in response to the failure, a second message instructing the accelerator to convey additional information regarding the failure associated with the context information. In some examples, the first message indicates a failure of the validation procedure, and the accelerator communicating manager 930 is capable of, configured to, or operable to support a means for obtaining, from the accelerator in response to the second message, a third message including the additional information associated with the context information, for the communications between the accelerator and the RU.

In some examples, the configuration information manager 945 is capable of, configured to, or operable to support a means for obtaining, based on the additional information, second additional information for a second data model. In some examples, the accelerator communicating manager 930 is capable of, configured to, or operable to support a means for providing, to the accelerator, a fourth message conveying the second additional information.

In some examples, the first message indicates a failure of the validation procedure, and the accelerator communicating manager 930 is capable of, configured to, or operable to support a means for providing, to the accelerator based on the failure, a second message identifying additional information for a second data model, where the additional information includes a modified version of the information.

In some examples, the first message indicates a failure of the validation procedure, and the accelerator communicating manager 930 is capable of, configured to, or operable to support a means for obtaining, from the accelerator based on the failure, an indication of additional information for a second data model, the additional information for producing a modified version of the information.

In some examples, the profile instance associated with the accelerator is associated with a carrier, a physical context, a baseband context associated with the accelerator, or any combination thereof. In some examples, the context information further includes an indication of applicable antenna panels associated with one or more transmission reception points. In some examples, the first identifier corresponds to at least two profile instances of a set of multiple profiles instances.

In some examples, the context information includes a first set of multiple identifiers associated with a set of multiple profile instances associated with the accelerator, a second set of multiple identifiers associated with a set of multiple RUs including the RU, a third set of multiple identifiers associated with a set of multiple applications including the application, or any combination thereof.

Additionally, or alternatively, the communications manager 920 may support wireless communication at an accelerator associated with a DU of a RAN in accordance with examples as disclosed herein. In some examples, the context information manager 925 is capable of, configured to, or operable to support a means for identifying context information including a first identifier associated with the accelerator, a second identifier associated with an application of the DU, a third identifier associated with a profile instance associated with the accelerator, a fourth identifier associated with an RU associated with the DU, or any combination thereof. The application communicating manager 935 is capable of, configured to, or operable to support a means for exchanging messages with the application based on the identified context information.

In some examples, to support exchanging the messages, the application communicating manager 935 is capable of, configured to, or operable to support a means for obtaining the context information from the application. In some examples, to support exchanging the messages, the application communicating manager 935 is capable of, configured to, or operable to support a means for providing, to the application based on obtaining the context information, information associated with a data model hosted at the accelerator.

In some examples, to support exchanging the messages, the application communicating manager 935 is capable of, configured to, or operable to support a means for providing the context information to the application. In some examples, to support exchanging the messages, the application communicating manager 935 is capable of, configured to, or operable to support a means for obtaining, from the application based on providing the context information, information associated with a data model for communications between the accelerator and the RU associated with the DU.

In some examples, the application communicating manager 935 is capable of, configured to, or operable to support a means for providing, to the application based on obtaining the information, a first message indicating a result of a validation procedure associated with the information.

In some examples, the first message indicates a failure of the validation procedure, and the application communicating manager 935 is capable of, configured to, or operable to support a means for obtaining, from the application in response to the failure, a second message instructing the accelerator to convey additional information regarding the failure associated with the context information. In some examples, the first message indicates a failure of the validation procedure, and the application communicating manager 935 is capable of, configured to, or operable to support a means for providing, to the application in response to the second message, a third message including the additional information associated with the context information, for communications between the accelerator and the RU.

In some examples, the configuration information manager 945 is capable of, configured to, or operable to support a means for obtaining, from the application in response to the failure, a fourth message including second additional information for a second data model.

In some examples, the configuration information manager 945 is capable of, configured to, or operable to support a means for obtaining, from the application, a first message including information relevant to a second data model. In some examples, the validation procedure manager 950 is capable of, configured to, or operable to support a means for determining a failure of a validation procedure associated with the information. In some examples, the application communicating manager 935 is capable of, configured to, or operable to support a means for providing, to the application based on the failure, a second message indicating a third information, where the third information is associated with a modified version of the information.

In some examples, the profile instance associated with the accelerator is associated with a carrier, a physical context, a baseband context associated with the accelerator, or any combination thereof. In some examples, the context information further includes an indication of applicable antenna panels associated with one or more transmission reception points associated with the DU. In some examples, the first identifier corresponds to at least two profile instances of a set of multiple profiles instances.

In some examples, the context information includes a first set of multiple identifiers associated with a set of multiple profile instances associated with the accelerator, a second set of multiple identifiers associated with a set of multiple RUs including the RU, a third set of multiple identifiers associated with a set of multiple applications including the application, or any combination thereof.

Additionally, or alternatively, the communications manager 920 may support wireless communication at an application executable by a DU of a RAN in accordance with examples as disclosed herein. In some examples, the accelerator communicating manager 930 may be configured as or otherwise support a means for communicating a first message with an accelerator of the DU, the first message including context information associated with a data model hosted at the accelerator or the application. In some examples, the accelerator communicating manager 930 may be configured as or otherwise support a means for communicating a second message with the accelerator based on the context information, the second message including configuration information associated with the data model.

In some examples, the context information includes a first identifier associated with the accelerator, a second identifier associated with the RU, a third identifier associated with a profile instance associated with the accelerator, or a fourth identifier associated with the application.

In some examples, the accelerator is associated with a set of multiple profile instances including the profile instance. In some examples, first identifier corresponds to at least two profile instances of the set of multiple profiles instances.

In some examples, the context information includes a set of multiple identifiers associated with a set of multiple profile instances associated with the accelerators, a set of multiple identifiers associated with a set of multiple RUs including the RU, a set of multiple identifiers associated with a set of multiple applications including the application, or any combination thereof. In some examples, the configuration information is associated with the set of multiple profile instances, the set of multiple RUs, the set of multiple applications, or any combination thereof.

In some examples, the accelerator communicating manager 930 may be configured as or otherwise support a means for obtaining, from the accelerator based on providing the second message, a third message indicating a result of a validation procedure associated with the configuration information.

In some examples, the third message indicates a failure of the validation procedure, and the accelerator communicating manager 930 may be configured as or otherwise support a means for providing, to the accelerator in response to the failure, a fourth message instructing the accelerator to modify the context information. In some examples, the third message indicates a failure of the validation procedure, and the accelerator communicating manager 930 may be configured as or otherwise support a means for obtaining, from the accelerator in response to the fourth message, a fifth message including additional context information for the communications between the accelerator and the RU. In some examples, the third message indicates a failure of the validation procedure, and the configuration information manager 945 may be configured as or otherwise support a means for obtaining, based on the additional context information, additional configuration information for a second data model. In some examples, the third message indicates a failure of the validation procedure, and the accelerator communicating manager 930 may be configured as or otherwise support a means for providing, to the accelerator, a sixth message identifying the additional configuration information.

In some examples, the third message indicates a failure of the validation procedure, and the accelerator communicating manager 930 may be configured as or otherwise support a means for providing, to the accelerator based on the failure, a fourth message identifying additional configuration information for a second data model, where the additional configuration information includes a modified version of the configuration information.

In some examples, the third message indicates a failure of the validation procedure, and the accelerator communicating manager 930 may be configured as or otherwise support a means for obtaining, from the accelerator based on the failure, an indication of additional configuration information for a second data model, where the additional configuration information includes a modified version of the configuration information.

In some examples, the first message is obtained from the accelerator via an interface between the application and the accelerator.

In some examples, the accelerator communicating manager 930 may be configured as or otherwise support a means for communicating, with the accelerator, an exchange configuration for exchanging information associated with the data model between the application and the accelerator, where communicating the first message, communicating the second message, or both, is based on the exchange configuration.

In some examples, the exchange configuration includes one or more rules, one or more conditions, or both, for modifying the data model.

In some examples, the RU communicating manager 940 may be configured as or otherwise support a means for providing, to the RU via an interface between the application and the RU and based on the context information, a request for the configuration information. In some examples, the RU communicating manager 940 may be configured as or otherwise support a means for obtaining the configuration information from the RU via the interface the application and the RU and based on the request, where communicating the second message is based on the obtaining.

In some examples, the RU communicating manager 940 may be configured as or otherwise support a means for obtaining, from the RU via an interface between the application and the RU, additional configuration information associated with the data model for communications between the accelerator and the RU. In some examples, the RU communicating manager 940 may be configured as or otherwise support a means for providing, to the RU, a third message indicating a failure of a validation procedure associated with the additional configuration information and performed at the application, where the configuration information is obtained from the RU based on the third message.

In some examples, the configuration information manager 945 may be configured as or otherwise support a means for obtaining the configuration information via a cache maintained at the application, where communicating the second message is based on the obtaining.

In some examples, the configuration information includes a capability associated with the RU, a set of parameters associated with communications performed by the RU, or a status associated with processing of the first message, or any combination thereof.

In some examples, the accelerator communicating manager 930 may be configured as or otherwise support a means for providing the first message including the context information to the accelerator. In some examples, the accelerator communicating manager 930 may be configured as or otherwise support a means for obtaining the second message from the accelerator based on providing the first message, where the data model is hosted at the accelerator.

Additionally, or alternatively, the communications manager 920 may support wireless communication at an accelerator associated with a DU of a RAN in accordance with examples as disclosed herein. In some examples, the application communicating manager 935 may be configured as or otherwise support a means for communicating a first message with an application executable by the DU, the first message including context information associated with a data model hosted at the accelerator or the application. In some examples, the application communicating manager 935 may be configured as or otherwise support a means for communicating a second message with the application based on the context information, the second message including configuration information associated with the data model.

In some examples, the context information includes a first identifier associated with the accelerator, a second identifier associated with the RU, a third identifier associated with a profile instance associated with the accelerator, or a fourth identifier associated with the application.

In some examples, the accelerator is associated with a set of multiple profile instances including the profile instance. In some examples, first identifier corresponds to at least two profile instances of the set of multiple profiles instances.

In some examples, the context information includes a set of multiple identifiers associated with a set of multiple profile instances associated with the accelerator, a set of multiple identifiers associated with a set of multiple RUs including the RU, a set of multiple identifiers associated with a set of multiple applications including the application, or any combination thereof. In some examples, the configuration information is associated with the set of multiple profile instances, the set of multiple RUs, the set of multiple applications, or any combination thereof.

In some examples, the application communicating manager 935 may be configured as or otherwise support a means for providing, to the application based on obtaining the second message, a third message indicating a result of a validation procedure associated with the configuration information.

In some examples, the application communicating manager 935 may be configured as or otherwise support a means for obtaining, from the application, a third message including additional configuration information for a second data model. In some examples, the application communicating manager 935 may be configured as or otherwise support a means for providing, to the application based on obtaining the third message, a fourth message indicating a failure of a validation procedure associated with the additional configuration information. In some examples, the application communicating manager 935 may be configured as or otherwise support a means for obtaining, from the application in response to the failure, a fifth message instructing the accelerator to modify the context information. In some examples, the application communicating manager 935 may be configured as or otherwise support a means for providing, to the application in response to the fifth message, a sixth message including additional context information for the communications between the accelerator and the RU, where obtaining the second message including the configuration information is based on the sixth message.

In some examples, the configuration information manager 945 may be configured as or otherwise support a means for obtaining, from the application, a third message including additional configuration information for a second data model. In some examples, the application communicating manager 935 may be configured as or otherwise support a means for providing, to the application based on obtaining the third message, a fourth message indicating a failure of a validation procedure associated with the additional configuration information, where the second message including the configuration information is obtained based on the fourth message, and where the configuration information includes a modified version of the additional configuration information.

In some examples, the configuration information manager 945 may be configured as or otherwise support a means for obtaining, from the application, a third message including additional configuration information for a second data model. In some examples, the validation procedure manager 950 may be configured as or otherwise support a means for determining a failure of a validation procedure associated with the additional configuration information. In some examples, the application communicating manager 935 may be configured as or otherwise support a means for providing, to the application based on the failure, a fourth message indicating the configuration information, where the configuration information includes a modified version of the additional configuration information.

In some examples, the first message is provided to the application via an interface between the application and the accelerator.

In some examples, the application communicating manager 935 may be configured as or otherwise support a means for communicating, with the application, an exchange configuration for exchanging information associated with the data model between the application and the accelerator, where providing the first message, obtaining the second message, or both, is based on the exchange configuration.

In some examples, the exchange configuration includes one or more rules, one or more conditions, or both, for modifying the data model.

In some examples, the configuration information includes a capability associated with the RU, a set of parameters associated with communications performed by the RU, a status associated with processing of the first message, or any combination thereof.

In some examples, the application communicating manager 935 may be configured as or otherwise support a means for providing the first message including the context information to the application. In some examples, the application communicating manager 935 may be configured as or otherwise support a means for obtaining the second message including the configuration information from the application, where the data model is associated with communications between the accelerator and a RU coupled with the DU. In some examples, the RU communicating manager 940 may be configured as or otherwise support a means for communicating with the RU in accordance with the configuration information.

In some examples, communicating with the RU is performed via a physical layer interface between the accelerator and the RU.

In some examples, the application communicating manager 935 may be configured as or otherwise support a means for obtaining the first message including the context information from the application. In some examples, the application communicating manager 935 may be configured as or otherwise support a means for providing the second message to the application based on obtaining the first message, where the data model is hosted at the accelerator.

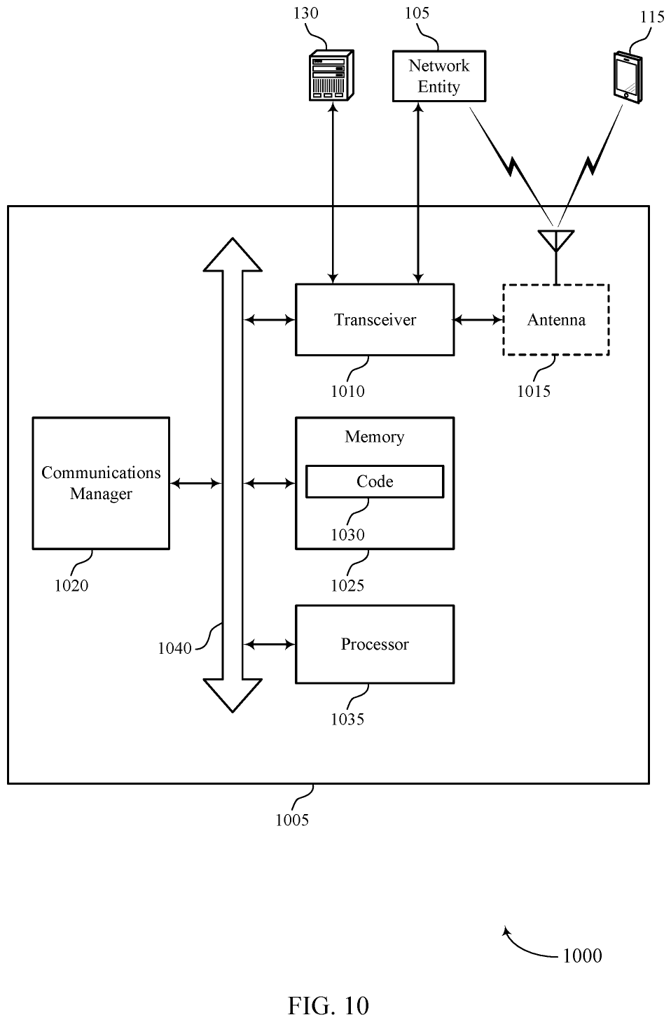

FIG. 10 shows a diagram of a system 1000 including a device 1005 that supports techniques for application and accelerator communications of a DU in accordance with one or more aspects of the present disclosure. The device 1005 may be an example of or include the components of a device 705, a device 805, or a network entity 105 as described herein. The device 1005 may communicate with one or more network entities 105, one or more UEs 115, or any combination thereof, which may include communications over one or more wired interfaces, over one or more wireless interfaces, or any combination thereof. The device 1005 may include components that support outputting and obtaining communications, such as a communications manager 1020, a transceiver 1010, an antenna 1015, a memory 1025, code 1030, and a processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or memory components (for example, the processor 1035, or the memory 1025, or both), may be included in a chip or chip assembly that is installed in the device 1005. The transceiver 1010, or the transceiver 1010 and one or more antennas 1015 or wired interfaces, where applicable, may be an example of a transmitter 715, a transmitter 815, a receiver 710, a receiver 810, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1025 may include RAM and ROM. The memory 1025 may store computer-readable, computer-executable code 1030 including instructions that, when executed by the processor 1035, cause the device 1005 to perform various functions described herein. The code 1030 may be stored in a non-transitory computer-readable medium such as system memory or another type of memory. In some cases, the code 1030 may not be directly executable by the processor 1035 but may cause a computer (e.g., when compiled and executed) to perform functions described herein. In some cases, the memory 1025 may contain, among other things, a BIOS which may control basic hardware or software operation such as the interaction with peripheral components or devices.

The processor 1035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1035 may be configured to operate a memory array using a memory controller. In some other cases, a memory controller may be integrated into the processor 1035. The processor 1035 may be configured to execute computer-readable instructions stored in a memory (e.g., the memory 1025) to cause the device 1005 to perform various functions (e.g., functions or tasks supporting techniques for application and accelerator communications of a DU). For example, the device 1005 or a component of the device 1005 may include a processor 1035 and memory 1025 coupled with the processor 1035, the processor 1035 and memory 1025 configured to perform various functions described herein. The processor 1035 may be an example of a cloud-computing platform (e.g., one or more physical nodes and supporting software such as operating systems, virtual machines, or container instances) that may host the functions (e.g., by executing code 1030) to perform the functions of the device 1005. The processor 1035 may be any one or more suitable processors capable of executing scripts or instructions of one or more software programs stored in the device 1005 (such as within the memory 1025). In some implementations, the processor 1035 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1035, or the transceiver 1010, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1005 may transmit information output from the chip or modem. In some implementations, the second interface may refer to an interface between the processing system of the chip or modem and a receiver, such that the device 1005 may obtain information or signal inputs, and the information may be passed to the processing system. A person having ordinary skill in the art will readily recognize that the first interface also may obtain information or signal inputs, and the second interface also may output information or signal outputs.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the memory 1025, the code 1030, and the processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X2 interface within an LTE/LTE-A wireless communications network technology to provide communication between network entities 105.

The communications manager 1020 may support wireless communication at an application executable by a DU of a RAN in accordance with examples as disclosed herein. For example, the communications manager 1020 may be configured as or otherwise support a means for identifying context information including a first identifier associated with an accelerator of the DU, a second identifier associated with the application, a third identifier associated with a profile instance associated with the accelerator, a fourth identifier associated with an RU associated with the DU, or any combination thereof. The communications manager 1020 is capable of, configured to, or operable to support a means for exchanging messages with the accelerator based on the identified context information.

Additionally, or alternatively, the communications manager 1020 may support wireless communication at an accelerator associated with a DU of a RAN in accordance with examples as disclosed herein. For example, the communications manager 1020 may be configured as or otherwise support a means for identifying context information including a first identifier associated with the accelerator, a second identifier associated with an application of the DU, a third identifier associated with a profile instance associated with the accelerator, a fourth identifier associated with an RU associated with the DU, or any combination thereof. The communications manager 1020 is capable of, configured to, or operable to support a means for exchanging messages with the application based on the identified context information.

Additionally, or alternatively, the communications manager 1020 may support wireless communication at an application executable by a DU of a RAN in accordance with examples as disclosed herein. For example, the communications manager 1020 may be configured as or otherwise support a means for communicating a first message with an accelerator of the DU, the first message including context information associated with a data model hosted at the accelerator or the application. The communications manager 1020 may be configured as or otherwise support a means for communicating a second message with the accelerator based on the context information, the second message including configuration information associated with the data model.

Additionally, or alternatively, the communications manager 1020 may support wireless communication at an accelerator associated with a DU of a RAN in accordance with examples as disclosed herein. For example, the communications manager 1020 may be configured as or otherwise support a means for communicating a first message with an application executable by the DU, the first message including context information associated with a data model hosted at the accelerator or the application. The communications manager 1020 may be configured as or otherwise support a means for communicating a second message with the application based on the context information, the second message including configuration information associated with the data model.

By including or configuring the communications manager 1020 in accordance with examples as described herein, the device 1005 may support techniques for exchanging context information between an application and an accelerator of a DU that enables the respective components to perform read/write operations on DMs hosted at the respective components. Techniques described herein may enable the M-plane interface between a DU and an RU of an O-RAN network entity 105 to be terminated at an application of the DU, as opposed to an accelerator of the DU. In particular, techniques of the present disclosure support signaling between the application and the accelerator of the DU which enables the M-plane interface to be terminated at the application. By enabling the M-plane interface to be terminated at the application, rather than the accelerator, techniques described herein may reduce or eliminate the need for the accelerator to relay DMs received from the RU to the application, thereby reducing signaling and processing performed at the DU. Additionally, by enabling the M-plane interface to be terminated at the application, techniques described herein may reduce the amount of processing operations that that are duplicated across both the application and the accelerator, thereby reducing power consumption and complexity of the DU and O-RAN network entity 105.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the processor 1035, the memory 1025, the code 1030, the transceiver 1010, or any combination thereof. For example, the code 1030 may include instructions executable by the processor 1035 to cause the device 1005 to perform various aspects of techniques for application and accelerator communications of a DU as described herein, or the processor 1035 and the memory 1025 may be otherwise configured to perform or support such operations.

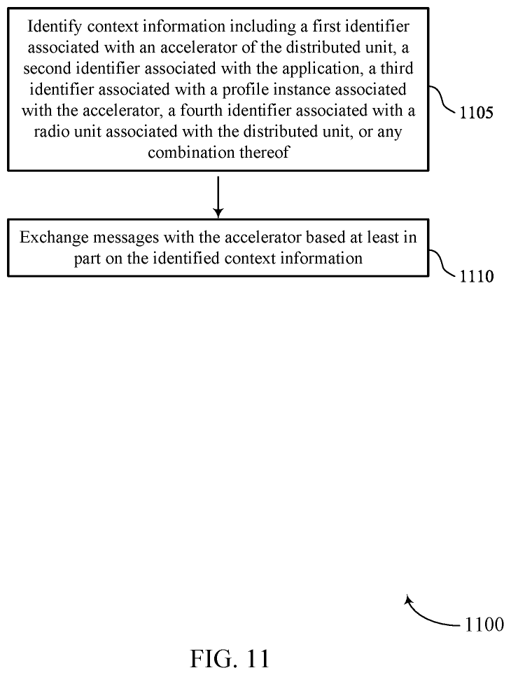

FIG. 11 shows a flowchart illustrating a method 1100 that supports techniques for application and accelerator communications of a DU in accordance with one or more aspects of the present disclosure. The operations of the method 1100 may be implemented by a network entity or its components as described herein. For example, the operations of the method 1100 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1105, the method may include identifying context information including a first identifier associated with an accelerator of the DU, a second identifier associated with the application, a third identifier associated with a profile instance associated with the accelerator, a fourth identifier associated with an RU associated with the DU, or any combination thereof. The operations of block 1105 may be performed in accordance with examples as disclosed herein. In some examples, aspects of the operations of 1105 may be performed by a context information manager 925 as described with reference to FIG. 9.

At 1110, the method may include exchanging messages with the accelerator based on the identified context information. The operations of block 1110 may be performed in accordance with examples as disclosed herein. In some examples, aspects of the operations of 1110 may be performed by an accelerator communicating manager 930 as described with reference to FIG. 9.

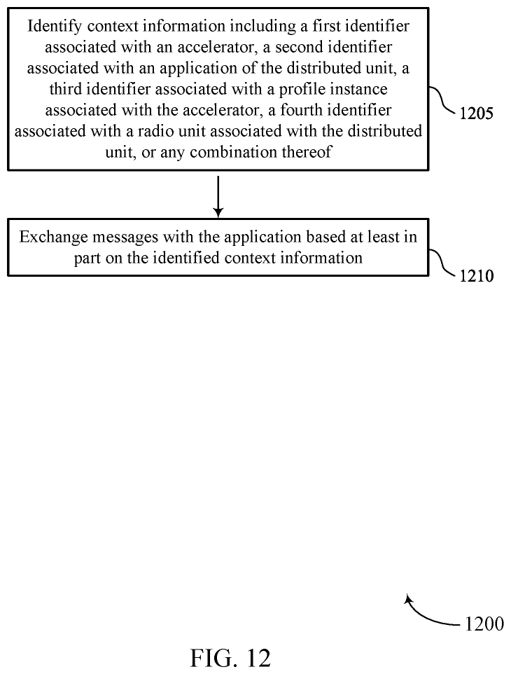

FIG. 12 shows a flowchart illustrating a method 1200 that supports techniques for application and accelerator communications of a DU in accordance with one or more aspects of the present disclosure. The operations of the method 1200 may be implemented by a network entity or its components as described herein. For example, the operations of the method 1200 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1205, the method may include identifying context information including a first identifier associated with the accelerator, a second identifier associated with an application of the DU, a third identifier associated with a profile instance associated with the accelerator, a fourth identifier associated with an RU associated with the DU, or any combination thereof. The operations of block 1205 may be performed in accordance with examples as disclosed herein. In some examples, aspects of the operations of 1205 may be performed by a context information manager 925 as described with reference to FIG. 9.

At 1210, the method may include exchanging messages with the application based on the identified context information. The operations of block 1210 may be performed in accordance with examples as disclosed herein. In some examples, aspects of the operations of 1210 may be performed by an application communicating manager 935 as described with reference to FIG. 9.

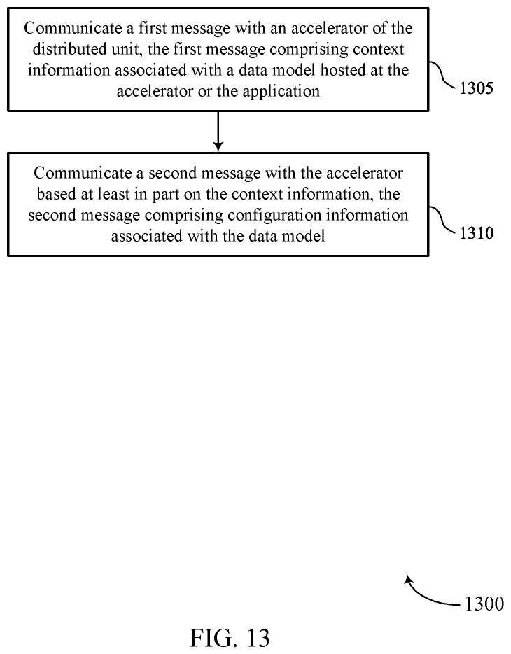

FIG. 13 shows a flowchart illustrating a method 1300 that supports techniques for application and accelerator communications of a DU in accordance with one or more aspects of the present disclosure. The operations of the method 1300 may be implemented by a network entity or its components as described herein. For example, the operations of the method 1300 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1305, the method may include communicating a first message with an accelerator of the DU, the first message including context information associated with a data model hosted at the accelerator or the application. The operations of 1305 may be performed in accordance with examples as disclosed herein. In some examples, aspects of the operations of 1305 may be performed by an accelerator communicating manager 930 as described with reference to FIG. 9.

At 1310, the method may include communicating a second message with the accelerator based on the context information, the second message including configuration information associated with the data model. The operations of 1310 may be performed in accordance with examples as disclosed herein. In some examples, aspects of the operations of 1310 may be performed by an accelerator communicating manager 930 as described with reference to FIG. 9.

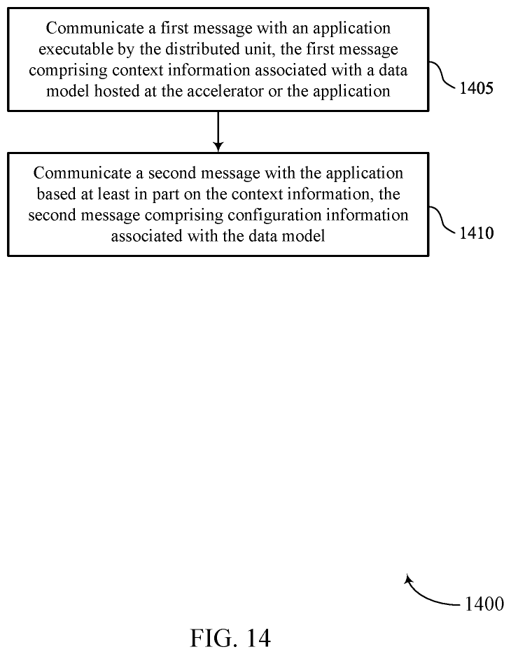

FIG. 14 shows a flowchart illustrating a method 1400 that supports techniques for application and accelerator communications of a DU in accordance with one or more aspects of the present disclosure. The operations of the method 1400 may be implemented by a network entity or its components as described herein. For example, the operations of the method 1400 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1405, the method may include communicating a first message with an application executable by the DU, the first message including context information associated with a data model hosted at the accelerator or the application. The operations of 1405 may be performed in accordance with examples as disclosed herein. In some examples, aspects of the operations of 1405 may be performed by an application communicating manager 935 as described with reference to FIG. 9.

At 1410, the method may include communicating a second message with the application based on the context information, the second message including configuration information associated with the data model. The operations of 1410 may be performed in accordance with examples as disclosed herein. In some examples, aspects of the operations of 1410 may be performed by an application communicating manager 935 as described with reference to FIG. 9.

The following provides an overview of aspects of the present disclosure:

Aspect 1: A method for wireless communication at an application executable by a DU of a RAN, comprising: identifying context information comprising a first identifier associated with an accelerator of the DU, a second identifier associated with the application, a third identifier associated with a profile instance associated with the accelerator, a fourth identifier associated with an RU associated with the DU, or any combination thereof; and exchanging messages with the accelerator based at least in part on the identified context information.

Aspect 2: The method of aspect 1, wherein exchanging the messages further comprises: providing the context information to the accelerator; and obtaining, from the accelerator based at least in part on providing the context information, information associated with a DM hosted at the accelerator.

Aspect 3: The method of any of aspects 1 through 2, wherein exchanging the messages further comprises: obtaining the context information from the accelerator; and providing, to the accelerator based at least in part on obtaining the context information, information associated with a DM for communications between the accelerator and the RU associated with the DU.

Aspect 4: The method of aspect 3, further comprising: providing, to the RU via an interface between the application and the RU, a request for the information; and obtaining the information from the RU via the interface and in response to the request, where the information obtained from the RU is further conveyed to the accelerator via a second interface between the application and the accelerator.

Aspect 5: The method of any of aspects 3 through 4, further comprising: obtaining, from the accelerator based at least in part on providing the information, a first message indicating a result of a validation procedure associated with the information.

Aspect 6: The method of aspect 5, wherein the first message indicates a failure of the validation procedure, the method further comprising: providing, to the accelerator in response to the failure, a second message instructing the accelerator to convey additional information regarding the failure associated with the context information; and obtaining, from the accelerator in response to the second message, a third message comprising the additional information associated with the context information, for the communications between the accelerator and the RU.

Aspect 7: The method of aspect 6, further comprising: obtaining, based at least in part on the additional information, second additional information for a second DM; and providing, to the accelerator, a fourth message conveying the second additional information.

Aspect 8: The method of aspect 5, wherein the first message indicates a failure of the validation procedure, the method further comprising: providing, to the accelerator based at least in part on the failure, a second message identifying additional information for a second DM, wherein the additional information comprises a modified version of the information.

Aspect 9: The method of any of aspects 5 through 7, wherein the first message indicates a failure of the validation procedure, the method further comprising: obtaining, from the accelerator based at least in part on the failure, an indication of additional information for a second DM, the additional information for producing a modified version of the information.

Aspect 10: The method of any of aspects 1 through 9, wherein the profile instance associated with the accelerator is associated with a carrier, a physical context, a baseband context associated with the accelerator, or any combination thereof.

Aspect 11: The method of any of aspects 1 through 10, wherein the context information further comprises an indication of applicable antenna panels associated with one or more transmission reception points.

Aspect 12: The method of any of aspects 1 through 11, wherein the first identifier corresponds to at least two profile instances of a plurality of profiles instances.

Aspect 13: The method of any of aspects 1 through 12, wherein the context information comprises a first plurality of identifiers associated with a plurality of profile instances associated with the accelerator, a second plurality of identifiers associated with a plurality of RUs including the RU, a third plurality of identifiers associated with a plurality of applications including the application, or any combination thereof.

Aspect 14: A method for wireless communication at an accelerator associated with a DU of a RAN, comprising: identifying context information comprising a first identifier associated with the accelerator, a second identifier associated with an application of the DU, a third identifier associated with a profile instance associated with the accelerator, a fourth identifier associated with an RU associated with the DU, or any combination thereof; and exchanging messages with the application based at least in part on the identified context information.

Aspect 15: The method of aspect 14, wherein exchanging the messages further comprises: obtaining the context information from the application; and providing, to the application based at least in part on obtaining the context information, information associated with a DM hosted at the accelerator.

Aspect 16: The method of any of aspects 14 through 15, wherein exchanging the messages further comprises: providing the context information to the application; and obtaining, from the application based at least in part on providing the context information, information associated with a DM for communications between the accelerator and the RU associated with the DU.

Aspect 17: The method of aspect 16, further comprising: providing, to the application based at least in part on obtaining the information, a first message indicating a result of a validation procedure associated with the information.

Aspect 18: The method of aspect 17, wherein the first message indicates a failure of the validation procedure, the method further comprising: obtaining, from the application in response to the failure, a second message instructing the accelerator to convey additional information regarding the failure associated with the context information; and providing, to the application in response to the second message, a third message comprising the additional information associated with the context information, for communications between the accelerator and the RU.

Aspect 19: The method of aspect 18, further comprising: obtaining, from the application in response to the failure, a fourth message comprising second additional information for a second DM.

Aspect 20: The method of any of aspects 14 through 16, further comprising: obtaining, from the application, a first message comprising information relevant to a second DM; determining a failure of a validation procedure associated with the information; and providing, to the application based at least in part on the failure, a second message indicating a third information, wherein the third information is associated with a modified version of the information.

Aspect 21: The method of any of aspects 14 through 20, wherein the profile instance associated with the accelerator is associated with a carrier, a physical context, a baseband context associated with the accelerator, or any combination thereof.

Aspect 22: The method of any of aspects 14 through 21, wherein the context information further comprises an indication of applicable antenna panels associated with one or more transmission reception points associated with the DU.

Aspect 23: The method of any of aspects 14 through 22, wherein the first identifier corresponds to at least two profile instances of a plurality of profiles instances.

Aspect 24: The method of any of aspects 14 through 23, wherein the context information comprises a first plurality of identifiers associated with a plurality of profile instances associated with the accelerator, a second plurality of identifiers associated with a plurality of RUs including the RU, a third plurality of identifiers associated with a plurality of applications including the application, or any combination thereof.

Aspect 25: An apparatus for wireless communication at an application executable by a DU of a RAN, comprising at least one processor; at least one memory coupled with the at least one processor; and instructions stored in the at least one memory and executable by the at least one processor to cause the apparatus to perform a method of any of aspects 1 through 13.

Aspect 26: An apparatus for wireless communication at an application executable by a DU of a RAN, comprising at least one means for performing a method of any of aspects 1 through 13.

Aspect 27: A non-transitory computer-readable medium storing code for wireless communication at an application executable by a DU of a RAN, the code comprising instructions executable by a processor to perform a method of any of aspects 1 through 13.

Aspect 28: An apparatus for wireless communication at an accelerator associated with a DU of a RAN, comprising at least one processor; at least one memory coupled with the at least one processor; and instructions stored in the at least one memory and executable by the at least one processor to cause the apparatus to perform a method of any of aspects 14 through 24.

Aspect 29: An apparatus for wireless communication at an accelerator associated with a DU of a RAN, comprising at least one means for performing a method of any of aspects 14 through 24.

Aspect 30: A non-transitory computer-readable medium storing code for wireless communication at an accelerator associated with a DU of a RAN, the code comprising instructions executable by a processor to perform a method of any of aspects 14 through 24.

Aspect 31: A method for wireless communication at an application executable by a DU of a RAN, comprising: communicating a first message with an accelerator of the DU, the first message comprising context information associated with a DM hosted at the accelerator or the application; and communicating a second message with the accelerator based at least in part on the context information, the second message comprising configuration information associated with the DM.

Aspect 32: The method of aspect 31, wherein the context information comprises a first identifier associated with the accelerator, a second identifier associated with the RU, a third identifier associated with a profile instance associated with the accelerator, or a fourth identifier associated with the application.

Aspect 33: The method of aspect 32, wherein the accelerator is associated with a plurality of profile instances including the profile instance, and first identifier corresponds to at least two profile instances of the plurality of profiles instances.

Aspect 34: The method of any of aspects 31 through 33, wherein the context information comprises a plurality of identifiers associated with a plurality of profile instances associated with the accelerators, a plurality of identifiers associated with a plurality of RUs including the RU, a plurality of identifiers associated with a plurality of applications including the application, or any combination thereof, the configuration information is associated with the plurality of profile instances, the plurality of RUs, the plurality of applications, or any combination thereof.

Aspect 35: The method of any of aspects 31 through 34, further comprising: obtaining, from the accelerator based at least in part on providing the second message, a third message indicating a result of a validation procedure associated with the configuration information.

Aspect 36: The method of aspect 35, wherein the third message indicates a failure of the validation procedure, the method further comprising: providing, to the accelerator in response to the failure, a fourth message instructing the accelerator to modify the context information; obtaining, from the accelerator in response to the fourth message, a fifth message comprising additional context information for the communications between the accelerator and the RU; obtaining, based at least in part on the additional context information, additional configuration information for a second DM; and providing, to the accelerator, a sixth message identifying the additional configuration information.

Aspect 37: The method of any of aspects 35 through 36, wherein the third message indicates a failure of the validation procedure, the method further comprising: providing, to the accelerator based at least in part on the failure, a fourth message identifying additional configuration information for a second DM, wherein the additional configuration information comprises a modified version of the configuration information.

Aspect 38: The method of any of aspects 35 through 37, wherein the third message indicates a failure of the validation procedure, the method further comprising: obtaining, from the accelerator based at least in part on the failure, an indication of additional configuration information for a second DM, wherein the additional configuration information comprises a modified version of the configuration information.

Aspect 39: The method of any of aspects 31 through 38, wherein the first message is obtained from the accelerator via an interface between the application and the accelerator.

Aspect 40: The method of any of aspects 31 through 39, further comprising: communicating, with the accelerator, an exchange configuration for exchanging information associated with the DM between the application and the accelerator, wherein communicating the first message, communicating the second message, or both, is based at least in part on the exchange configuration.

Aspect 41: The method of aspect 40, wherein the exchange configuration comprises one or more rules, one or more conditions, or both, for modifying the DM.

Aspect 42: The method of any of aspects 31 through 41, further comprising: providing, to the RU via an interface between the application and the RU and based at least in part on the context information, a request for the configuration information; and obtaining the configuration information from the RU via the interface the application and the RU and based at least in part on the request, wherein communicating the second message is based at least in part on the obtaining.

Aspect 43: The method of any of aspects 31 through 42, further comprising: obtaining, from the RU via an interface between the application and the RU, additional configuration information associated with the DM for communications between the accelerator and the RU; and providing, to the RU, a third message indicating a failure of a validation procedure associated with the additional configuration information and performed at the application, wherein the configuration information is obtained from the RU based at least in part on the third message.

Aspect 44: The method of any of aspects 31 through 43, further comprising: obtaining the configuration information via a cache maintained at the application, wherein communicating the second message is based at least in part on the obtaining.

Aspect 45: The method of any of aspects 31 through 44, wherein the configuration information comprises a capability associated with the RU, a set of parameters associated with communications performed by the RU, or a status associated with processing of the first message, or any combination thereof.

Aspect 46: The method of any of aspects 31 through 45, further comprising: providing the first message comprising the context information to the accelerator; and obtaining the second message from the accelerator based at least in part on providing the first message, wherein the DM is hosted at the accelerator.

Aspect 47: A method for wireless communication at an accelerator associated with a DU of a RAN, comprising: communicating a first message with an application executable by the DU, the first message comprising context information associated with a DM hosted at the accelerator or the application; and communicating a second message with the application based at least in part on the context information, the second message comprising configuration information associated with the DM.

Aspect 48: The method of aspect 47, wherein the context information comprises a first identifier associated with the accelerator, a second identifier associated with the RU, a third identifier associated with a profile instance associated with the accelerator, or a fourth identifier associated with the application.

Aspect 49: The method of aspect 48, wherein the accelerator is associated with a plurality of profile instances including the profile instance, and first identifier corresponds to at least two profile instances of the plurality of profiles instances.

Aspect 50: The method of any of aspects 47 through 49, wherein the context information comprises a plurality of identifiers associated with a plurality of profile instances associated with the accelerator, a plurality of identifiers associated with a plurality of RUs including the RU, a plurality of identifiers associated with a plurality of applications including the application, or any combination thereof, the configuration information is associated with the plurality of profile instances, the plurality of RUs, the plurality of applications, or any combination thereof.

Aspect 51: The method of any of aspects 47 through 50, further comprising: providing, to the application based at least in part on obtaining the second message, a third message indicating a result of a validation procedure associated with the configuration information.

Aspect 52: The method of any of aspects 47 through 51, further comprising: obtaining, from the application, a third message comprising additional configuration information for a second DM; providing, to the application based at least in part on obtaining the third message, a fourth message indicating a failure of a validation procedure associated with the additional configuration information; obtaining, from the application in response to the failure, a fifth message instructing the accelerator to modify the context information; and providing, to the application in response to the fifth message, a sixth message comprising additional context information for the communications between the accelerator and the RU, wherein obtaining the second message comprising the configuration information is based at least in part on the sixth message.

Aspect 53: The method of any of aspects 47 through 52, further comprising: obtaining, from the application, a third message comprising additional configuration information for a second DM; and providing, to the application based at least in part on obtaining the third message, a fourth message indicating a failure of a validation procedure associated with the additional configuration information, wherein the second message comprising the configuration information is obtained based at least in part on the fourth message, and wherein the configuration information comprises a modified version of the additional configuration information.

Aspect 54: The method of any of aspects 47 through 53, further comprising: obtaining, from the application, a third message comprising additional configuration information for a second DM; determining a failure of a validation procedure associated with the additional configuration information; and providing, to the application based at least in part on the failure, a fourth message indicating the configuration information, wherein the configuration information comprises a modified version of the additional configuration information.

Aspect 55: The method of any of aspects 47 through 54, wherein the first message is provided to the application via an interface between the application and the accelerator.

Aspect 56: The method of any of aspects 47 through 55, further comprising: communicating, with the application, an exchange configuration for exchanging information associated with the DM between the application and the accelerator, wherein providing the first message, obtaining the second message, or both, is based at least in part on the exchange configuration.

Aspect 57: The method of aspect 56, wherein the exchange configuration comprises one or more rules, one or more conditions, or both, for modifying the DM.

Aspect 58: The method of any of aspects 47 through 57, wherein the configuration information comprises a capability associated with the RU, a set of parameters associated with communications performed by the RU, a status associated with processing of the first message, or any combination thereof.

Aspect 59: The method of any of aspects 47 through 58, further comprising: providing the first message comprising the context information to the application; obtaining the second message comprising the configuration information from the application, wherein the DM is associated with communications between the accelerator and an RU coupled with the DU; and communicating with the RU in accordance with the configuration information.

Aspect 60: The method of aspect 59, wherein communicating with the RU is performed via a physical layer interface between the accelerator and the RU.

Aspect 61: The method of any of aspects 47 through 60, further comprising: obtaining the first message comprising the context information from the application; and providing the second message to the application based at least in part on obtaining the first message, wherein the DM is hosted at the accelerator.

Aspect 62: An apparatus for wireless communication at an application executable by a DU of a RAN, comprising a processor; memory coupled with the processor; and instructions stored in the memory and executable by the processor to cause the apparatus to perform a method of any of aspects 31 through 46.

Aspect 63: An apparatus for wireless communication at an application executable by a DU of a RAN, comprising at least one means for performing a method of any of aspects 31 through 46.

Aspect 64: A non-transitory computer-readable medium storing code for wireless communication at an application executable by a DU of a RAN, the code comprising instructions executable by a processor to perform a method of any of aspects 31 through 46.

Aspect 65: An apparatus for wireless communication at an accelerator associated with a DU of a RAN, comprising a processor; memory coupled with the processor; and instructions stored in the memory and executable by the processor to cause the apparatus to perform a method of any of aspects 47 through 61.

Aspect 66: An apparatus for wireless communication at an accelerator associated with a DU of a RAN, comprising at least one means for performing a method of any of aspects 47 through 61.

Aspect 67: A non-transitory computer-readable medium storing code for wireless communication at an accelerator associated with a DU of a RAN, the code comprising instructions executable by a processor to perform a method of any of aspects 47 through 61.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at an application executable by a distributed unit of a radio access network (RAN), comprising:
at least one processor;
at least one memory coupled with the at least one processor; and
instructions stored in the at least one memory and executable by the at least one processor to cause the apparatus to:
identify context information comprising a first identifier associated with an accelerator of the distributed unit, a second identifier associated with the application, a third identifier associated with a profile instance associated with the accelerator, a fourth identifier associated with a radio unit associated with the distributed unit, or any combination thereof; and
exchange messages with the accelerator based at least in part on the identified context information.

2. The apparatus of claim 1, wherein the instructions to exchange the messages are executable by the at least one processor to cause the apparatus to:
provide the context information to the accelerator; and
obtain, from the accelerator based at least in part on providing the context information, information associated with a data model hosted at the accelerator.

3. The apparatus of claim 1, wherein the instructions to exchange the messages are executable by the at least one processor to cause the apparatus to:
obtain the context information from the accelerator; and
provide, to the accelerator based at least in part on obtaining the context information, information associated with a data model for communications between the accelerator and the radio unit associated with the distributed unit.

4. The apparatus of claim 3, wherein the instructions are further executable by the at least one processor to cause the apparatus to:
provide, to the radio unit via an interface between the application and the radio unit, a request for the information; and
obtain the information from the radio unit via the interface and in response to the request, wherein the information from the radio unit is further conveyed to the accelerator via a second interface between the application and the accelerator.

5. The apparatus of claim 3, wherein the instructions are further executable by the at least one processor to cause the apparatus to:
obtain, from the accelerator based at least in part on providing the information, a first message indicating a result of a validation procedure associated with the information.

6. The apparatus of claim 5, wherein the first message indicates a failure of the validation procedure, and the instructions are further executable by the at least one processor to cause the apparatus to:
provide, to the accelerator in response to the failure, a second message instructing the accelerator to convey additional information regarding the failure associated with the context information; and
obtain, from the accelerator in response to the second message, a third message comprising the additional information associated with the context information, for the communications between the accelerator and the radio unit.

7. The apparatus of claim 6, wherein the instructions are further executable by the at least one processor to cause the apparatus to:
obtain, based at least in part on the additional information, second additional information for a second data model; and
provide, to the accelerator, a fourth message conveying the second additional information.

8. The apparatus of claim 5, wherein the first message indicates a failure of the validation procedure, and the instructions are further executable by the at least one processor to cause the apparatus to:
provide, to the accelerator based at least in part on the failure, a second message identifying additional information for a second data model, wherein the additional information comprises a modified version of the information.

9. The apparatus of claim 5, wherein the first message indicates a failure of the validation procedure, and the instructions are further executable by the at least one processor to cause the apparatus to:
obtain, from the accelerator based at least in part on the failure, an indication of additional information for a second data model, the additional information for producing a modified version of the information.

10. The apparatus of claim 1, wherein the profile instance associated with the accelerator is associated with a carrier, a physical context, a baseband context associated with the accelerator, or any combination thereof.

11. The apparatus of claim 1, wherein the context information further comprises an indication of applicable antenna panels associated with one or more transmission reception points.

12. The apparatus of claim 1, wherein the first identifier corresponds to at least two profile instances of a plurality of profiles instances.

13. The apparatus of claim 1, wherein the context information comprises a first plurality of identifiers associated with a plurality of profile instances associated with the accelerator, a second plurality of identifiers associated with a plurality of radio units including the radio unit, a third plurality of identifiers associated with a plurality of applications including the application, or any combination thereof.

14. An apparatus for wireless communication at an accelerator associated with a distributed unit of a radio access network (RAN), comprising:
at least one processor;
at least one memory coupled with the at least one processor; and
instructions stored in the at least one memory and executable by the at least one processor to cause the apparatus to:
identify context information comprising a first identifier associated with the accelerator, a second identifier associated with an application of the distributed unit, a third identifier associated with a profile instance associated with the accelerator, a fourth identifier associated with a radio unit associated with the distributed unit, or any combination thereof; and
exchange messages with the application based at least in part on the identified context information.

15. The apparatus of claim 14, wherein the instructions to exchange the messages are executable by the at least one processor to cause the apparatus to:
obtain the context information from the application; and
provide, to the application based at least in part on obtaining the context information, information associated with a data model hosted at the accelerator.

16. The apparatus of claim 14, wherein the instructions to exchange the messages are executable by the at least one processor to cause the apparatus to:
provide the context information to the application; and
obtain, from the application based at least in part on providing the context information, information associated with a data model for communications between the accelerator and the radio unit associated with the distributed unit.

17. The apparatus of claim 16, wherein the instructions are further executable by the at least one processor to cause the apparatus to:
provide, to the application based at least in part on obtaining the information, a first message indicating a result of a validation procedure associated with the information.

18. The apparatus of claim 17, wherein the first message indicates a failure of the validation procedure, and the instructions are further executable by the at least one processor to cause the apparatus to:
obtain, from the application in response to the failure, a second message instructing the accelerator to convey additional information regarding the failure associated with the context information; and
provide, to the application in response to the second message, a third message comprising the additional information associated with the context information, for communications between the accelerator and the radio unit.

19. The apparatus of claim 18, wherein the instructions are further executable by the at least one processor to cause the apparatus to:
obtain, from the application in response to the failure, a fourth message comprising second additional information for a second data model.

20. The apparatus of claim 14, wherein the instructions are further executable by the at least one processor to cause the apparatus to:
obtain, from the application, a first message comprising information relevant to a second data model;
determine a failure of a validation procedure associated with the information; and
provide, to the application based at least in part on the failure, a second message indicating a third information, wherein the third information is associated with a modified version of the information.

21. The apparatus of claim 14, wherein the profile instance associated with the accelerator is associated with a carrier, a physical context, a baseband context associated with the accelerator, or any combination thereof.

22. The apparatus of claim 14, wherein the context information further comprises an indication of applicable antenna panels associated with one or more transmission reception points associated with the distributed unit.

23. The apparatus of claim 14, wherein the first identifier corresponds to at least two profile instances of a plurality of profiles instances.

24. The apparatus of claim 14, wherein the context information comprises a first plurality of identifiers associated with a plurality of profile instances associated with the accelerator, a second plurality of identifiers associated with a plurality of radio units including the radio unit, a third plurality of identifiers associated with a plurality of applications including the application, or any combination thereof.

25. A method for wireless communication at an application executable by a distributed unit of a radio access network (RAN), comprising:
identifying context information comprising a first identifier associated with an accelerator of the distributed unit, a second identifier associated with the application, a third identifier associated with a profile instance associated with the accelerator, a fourth identifier associated with a radio unit associated with the distributed unit, or any combination thereof; and
exchanging messages with the accelerator based at least in part on the identified context information.

26. The method of claim 25, wherein exchanging the messages further comprises:
providing the context information to the accelerator; and
obtaining, from the accelerator based at least in part on providing the context information, information associated with a data model hosted at the accelerator.

27. The method of claim 25, wherein exchanging the messages further comprises:
obtaining the context information from the accelerator; and
providing, to the accelerator based at least in part on obtaining the context information, information associated with a data model for communications between the accelerator and the radio unit associated with the distributed unit.

28. A method for wireless communication at an accelerator associated with a distributed unit of a radio access network (RAN), comprising:
identifying context information comprising a first identifier associated with the accelerator, a second identifier associated with an application of the distributed unit, a third identifier associated with a profile instance associated with the accelerator, a fourth identifier associated with a radio unit associated with the distributed unit, or any combination thereof; and
exchanging messages with the application based at least in part on the identified context information.

29. The method of claim 28, wherein exchanging the messages further comprises:
obtaining the context information from the application; and
providing, to the application based at least in part on obtaining the context information, information associated with a data model hosted at the accelerator.

30. The method of claim 28, wherein exchanging the messages further comprises:
providing the context information to the application; and
obtaining, from the application based at least in part on providing the context information, information associated with a data model for communications between the accelerator and the radio unit associated with the distributed unit.
